(19) United States
(12) Patent Application Publication
(10) Pub. No.: US 2008/0087554 A1
(43) Pub. Date: Apr. 17, 2008

(54) Electrochemical detection device

(75) Inventors: Michael C. Norris, Santa Clara, CA (US); Albert Yee, Roseville, CA (US)

Correspondence Address: PATTON BOGGS LLP, 8484 WESTPARK DRIVE, SUITE 900, MCLEAN, VA, 22102, US

(73) Assignee: Antara BioSciences Inc., Mountain View, CA (US)

(21) Appl. No.: 11/802,609

(22) Filed: May 24, 2007

Related U.S. Application Data
(60) Provisional application No. 60/802,950, filed on May 24, 2006.
(60) Provisional application No. 60/815,106, filed on Jun. 20, 2006.
(60) Provisional application No. 60/802,964, filed on May 24, 2006.

(51) Int. Cl. G01N 27/26; G01N 27/28

(52) U.S. Cl. 205/792; 204/403.01

(57) ABSTRACT

The present invention provides electrochemical detection devices useful for conducting diagnostic tests. The devices of the present invention can be used to detect a wide range of target agents, and is useful in analyzing biological samples (including blood and other bodily fluids), as well as air, water, soil and other environmental samples.

### CROSS REFERENCE TO RELATED APPLICATIONS

This application claims the benefit of U.S. Provisional Patent Application Ser. No. 60/802,950, filed May 24, 2006, currently pending; U.S. Provisional Patent Application Ser. No. 60/802,964, filed May 24, 2006, currently pending; and U.S. Provisional Patent Application Ser. No. 60/815,106, filed Jun. 20, 2006, currently pending, all of which are herein incorporated by reference in their entireties for all purposes.

### BACKGROUND

In the following discussion certain articles and methods will be described for background and introductory purposes. Nothing contained herein is to be construed as an “admission” of prior art. Applicant expressly reserves the right to demonstrate, where appropriate, that the articles and methods referenced herein do not constitute prior art under the applicable statutory provisions.

Devices for automatically conducting a diagnostic test utilizing, for example, a patient's blood or other bodily fluid in a laboratory, hospital or physician's office are generally well known. With such devices, a small biological sample from the patient (e.g., blood or other bodily fluid) is obtained by a health care professional for the purpose of conducting the analysis. In some devices, a biological sample is mixed with a preparatory solution or a dry or lyophilized activation reagent that is effectively re-hydrated when mixed with the sample. In some cases, the resulting mixture is then exposed to light at a particular wavelength and a photodetector receives the light signal reflected from the mixture to provide a resulting output diagnostic. Other such devices function in the same, similar or different ways and are known in the art. While some of these diagnostic devices are generally effective in performing medical diagnostic testing, they are often bulky and, therefore, are basically restricted to being used only in a laboratory or hospital or, in limited cases, a physician's office.

### BRIEF SUMMARY

There exists a need for reducing the size and footprint of diagnostic devices. In addition, there is a need for a device that is inexpensive, simple to install and easy to operate, yet provides a fast, effective, consistent result. Further, there is a need for small diagnostic devices that are single-use, portable, self-contained, and/or disposable. The present invention provides electrochemical detection devices that have certain advantages not provided by currently known diagnostic devices, such as a reduced size and footprint in comparison to current devices known in the art, such as Tohiba's Genelyzer™ instrument or the higher throughput Bioanalytical Systems, Inc. BASi Electrochemical Workstation. The devices of the present invention are capable of detecting a wide range of target agents, including certain chemicals, antibodies, antigens, hormones, metabolites, toxins, venoms, and the like. The devices of the present invention provide on-the-spot analysis in a very short time and the result of the analysis is provided by a readout on the device itself or, in some embodiments, provided by or stored within the memory of a networked PC. The devices of the present invention are inexpensive, simple to install, and easy to operate, yet provide a fast, effective, consistent result. Moreover, the accuracy of the results obtained using the present devices is unaffected by the level of medical training and/or laboratory skills of the user, as very little user interface is required. In addition, small diagnostic devices would prove particularly useful in the field, for example, in military and/or anti-bioterrorism applications.

In some embodiments, the present device provides a single-use, portable, self-contained diagnostic device small enough to fit into the palm of a user's hand. In certain embodiments, the present device provides on-the-spot analysis in a very short time, usually a few minutes, and the result of the analysis is provided by a readout on the device or, in some embodiments, stored within the memory of the device for later downloading or other retrieval. In addition, such a device allows longer duration tests to begin earlier, e.g., while still in the field, therefore providing results faster than devices that require transportation of the sample to a laboratory prior to initiation of the test.

In some embodiments, the present device solves the problem of detection for a wide range of target agents by combining the versatility of target agent recognition with the speed and sensitivity of electrochemical nucleic acid detection, while in turn eliminating the need for nucleic acid isolation, amplification, and/or labeling, and the problems associated with non-specific nucleic acid hybridization. The non-specific hybridization observed in other DNA detection methods currently known in the art is overcome by using a sensor having only known nucleic acid sequences for hybridization (sequences that, in a preferred embodiment, are rationally-designed to minimize the risk of non-specific hybridization), thereby ensuring that specific hybridization is optimized. Also, the single-stranded nucleic acids or oligos on the sensor employed in the present invention can be of many lengths and sequences, but preferably have lengths and sequences that prevent non-specific hybridization to one another, and prevent non-specific hybridization to sequences that may be present in the sample (e.g., human genomic sequences or genomic sequences from pathogens).

Seen in FIG. 1, one embodiment of the device of the present invention comprises a chassis (100), having a pump housing (104), a pump rotor (105) and a pump motor (106) for, e.g., a peristaltic pump, reagent reservoirs (110 a-d), valves (112 a-d) (in this embodiment, solenoid valves), a fan (114), a heat sink (116) having a bottom surface (117) with a heater disposed thereon (not shown), a pass through (122) for the electrical connection to the electrochemical detection chip, and a waste path (140). Also shown in FIG. 1 is an electrochemical detection chip (120), seen here in cross section.

Thus, in certain embodiments, the present invention provides an electrochemical detection device for detection of target agents comprising: a chassis on which is mounted cooling means, a control board and a processing board, wherein said chassis comprises at least three fluid paths and one or more air paths and wherein said chassis defines a pass through for an electrical connection, a cavity in which to mount an electrical circuit board and an aperture to accommodate a pump; a pump connected to said fluid paths; reagent reservoirs; at least two valves connecting said fluid paths to said reagent reservoirs; at least one valve connecting an air intake to said air path; a heating means; a thermal sensor; and means for electrically detecting a hybridization event between oligonucleotides.

Seen in FIG. 8, one embodiment of the device of the present invention comprises a detection device (201) having two modules: a chemistry module (202) and an electronics module (203). The chemistry module comprises a housing (204) having a plunger end (205) and a seal end (206). The plunger end (205) of the housing (204) of the chemistry module (202) is capable of receiving one or more plungers (218). Here one plunger (218) is shown. One plunger may be used instead of multiple plungers so long as the single plunger is configured so as to initiate the delivery of reagents from each of the reagent chambers (224 and 225, here), for example, by utilizing a rotatable plunger (218). The plunger is depressed sequentially so as to deliver reagents to the reaction chamber from the reagent chambers (224 and 225) through reagent ports (226 and 227). Chemistry module (202) also comprises a sample collection element (216) that protrudes from the seal end (206) of housing (204) and may be integral with the housing (204). Though in this particular embodiment a sample collection element (216) is shown, the present invention envisions embodiments where there would be no sample collection element. Instead, a sample could be introduced directly into reaction chamber (210). The chemistry module (202) further comprises at least two reagent chambers (224 and 225), fluidly connected to a chemistry module portion (28) of a reaction chamber (210) through reagent ports (226 and 227). The seal end (206) of housing (204) of the chemistry module (202) has an o-ring-like seal (220) that engages and forms a liquid-tight seal with a seal engaging surface (222) of housing (207) of the electronics module (203). The electronics module (203) further comprises a chamber end (08) forming a portion (229) of reaction chamber (210). The chamber end (208), of the electronics module (202) further comprises a filtered flow channel (230) in fluid connection with portion (229) of reaction chamber (210), where the filtered flow channel (230) is also in fluid connection with a electrochemical reagent chamber (238) through an electrochemical reagent port (240). The electronics module (203) further comprises an electronics end (209) comprising a sensor (212) having a plurality of sensor electrodes (214), electronics and power elements (234) as well as indicator lights (236). Though the present device may be used to detect a wide range of target agents, in preferred embodiments, the electronics module (203) remains constant between different assays, and only the chemistry module (202) changes, promoting ease in manufacturing and permitting the modules to be bundled in kits.

Thus, the present invention provides in one embodiment, a handheld device for the detection of target agents via hybridization of oligonucleotides comprising: a first module comprising a first housing forming one or more reagent chambers, wherein said first housing comprises at a first end, means for receiving one or more reagent delivery means and at a second end, a first chamber structure formed by said first housing, wherein said first chamber structure is fluidly connected to said one or more reagent chambers by one or more reagent ports; and a second module comprising a second housing forming a sensor chamber wherein said second housing comprises at a first end, a second chamber structure capable of coupling to said first chamber structure to form a substantially fluid-tight chamber around said sample collection element and at a second end comprises means to supply power to said handheld device, electronics to process an electrical signal and an indicator means, wherein said sensor chamber is fluidly connected to said second chamber by a sensor port, and wherein said sensor chamber comprises single-stranded oligonucleotides disposed upon an electrode and electrical means to generate an electrical signal if a hybridization event between oligonucleotides is detected.

In one aspect of the present invention, there is provided a method of electrochemically detecting the presence of a target agent in a sample. A particular embodiment includes the use of: (a) a sensor (212) comprising first single-stranded nucleic acid molecules immobilized on a plurality of electrodes (214); (b) a first reagent comprising a second single-stranded nucleic acid molecule that is complementary to the first single-stranded nucleic acid molecule, where the second single-stranded nucleic acid molecule is conjugated to a capture moiety specific for the target agent to be detected; (c) a second reagent comprising immobilized binding partners to the capture moiety; and (d) a sample suspected of containing the target agent. The method includes collecting a sample on a sample collection element (216) of the device (201), then coupling the chemistry module (202) to the electronics module (203), forming a liquid-tight environment through the engagement of seal (220) of housing (204) with the seal engaging surface (222) of housing (207). The coupling of the chemistry module (202) to the electronics module (203) forms a reaction chamber (210) having a portion (228) formed by housing (204), and a portion (229) formed by housing (207). The first reagent is stored in reagent chamber (224) and is delivered to the reaction chamber (210) through reagent port (226). Once the first reagent is delivered to the reaction chamber (210), the capture moiety of the second single-stranded nucleic acid molecule is allowed to bind the target agent of the sample. The second reagent containing immobilized binding partners to the capture moiety is stored in reagent chamber (225) and is delivered to the reaction chamber (210) from a reagent through reagent port (227). Unreacted capture moieties from the first reagent react with the immobilized binding partners, thereby removing unreacted capture moieties from solution, which are then filtered through the filtered flow channel (230) into the sensor chamber (232). As the solution passes through the filtered flow channel, an electrochemical indicator stored in electrochemical reagent chamber (238) also may be added to the solution. Once the solution reaches sensor chamber (232), the solution contacts the sensor (212) and the sensor electrodes (214) having the immobilized first single-stranded nucleic acid molecules thereon. If a hybridization event occurs between the first single-stranded nucleic acids immobilized on an electrode and the second single-stranded nucleic acid from the first reagent, target agent was present in the sample. The hybridization event is detected by electrochemical detection. The electrochemical detection can be direct or indirect.

In certain embodiments, as seen in FIG. 9, for example, the device further comprises a second reaction chamber between the reaction chamber 210 and the sensor chamber 212, where an enzyme can be added to cleave the capture moiety from the second set of single-stranded nucleic acid molecules following separation from the single-stranded nucleic acids with capture moieties that bound the immobilized binding partners. The cleavage of the capture moiety may be performed by any agent that is capable of cleaving between the capture moiety and a region of the single-stranded nucleic acid molecule that hybridizes to the single-stranded nucleic acid molecule that is immobilized on the electrode.

### BRIEF DESCRIPTION OF THE FIGURES

So that the manner in which the features, advantages, and objects of the present invention are attained and can be understood in detail, a more particular description of the invention, briefly summarized above, may be had by reference to the embodiments that are illustrated in the appended drawings. It is to be noted, however, that the appended drawings illustrate only certain embodiments of this invention and are therefore not to be considered limiting of its scope, for the present invention may admit to other equally effective embodiments.

FIG. 1 provides a pictorial view of one embodiment of the detection device of the present invention.

FIG. 2A provides an exploded view of one embodiment of the detection device of the present invention.

FIG. 2B provides a pictorial view of one embodiment of the detection device of the present invention.

FIG. 3A provides a side view of one embodiment of the detection device of the present invention.

FIG. 3B provides a sectional view of one embodiment of the detection device of the present invention taken through A-A of FIG. 3A.

FIG. 3C provides a front view of one embodiment of the detection device of the present invention.

FIG. 3D provides a top view of one embodiment of the detection device of the present invention.

FIG. 4 provides perspective view of one embodiment of the monoblock fluidics chassis useful in the present invention.

FIG. 5 provides a covered embodiment of the detection device seen in FIG. 2B.

FIG. 6 shows several view of one embodiment of a fluidic block that may be employed in the present invention.

FIG. 7 shows several views of one embodiment of a system assembly diagram.

FIGS. 8 A-C provide various views of one embodiment of the device of the present invention. FIG. 1A is a sectional view, FIG. 1B is a cross-sectional view through A-A of FIG. 1C, and FIG. 1C is a hidden line view.

FIGS. 9 A-C provide various views of an alternative embodiment of the device of the present invention. FIG. 2A is a sectional view, FIG. 2B is a cross-sectional view through A-A of FIG. 2C, and FIG. 2C is a hidden line view.

FIG. 10 provides hidden line views of a specific embodiments of the present invention.

FIG. 11 provides cross-section views of the embodiment presented in FIG. 10.

FIG. 12 illustrates orthogonal views of the embodiment presented in FIGS. 10 and 11.

FIG. 13 presents isometric views of the embodiment presented in FIGS. 10, 11, and 12.

### DEFINITIONS

The terms used herein are intended to have the plain and ordinary meaning as understood by those of ordinary skill in the art. The following definitions are intended to aid the reader in understanding the present invention, but are not intended to vary or otherwise limit the meaning of such terms unless specifically indicated. To the extent that the definitions presented in this specification differ from any definitions set forth implicitly or explicitly in any reference or priority document cited herein, it is to be understood that those presented herein are to be used in understanding the embodiments of the invention as set forth herein.

The term “nucleic acid molecules,” “oligonucleotides,” or “oligos” as used herein refers to oligomers of natural or modified nucleic acid monomers or linkages, including deoxyribonucleotides, ribonucleotides, anomeric forms thereof, peptide nucleic acid monomers (PNAs), locked nucleic acid monomers (LNA), and the like and/or combinations thereof, capable of specifically binding to a single-stranded polynucleotide by way of a regular pattern of monomer-to-monomer interactions, such as Watson-Crick type of base pairing, base stacking, Hoogsteen or reverse Hoogsteen types of base pairing, or the like. Usually monomers are linked by phosphodiester bonds or analogs thereof to form oligonucleotides ranging in size from a few monomeric units, e.g., 8-12, to several tens of monomeric units, e.g., 100-200. Suitable nucleic acid molecules may be prepared by the phosphoramidite method described by Beaucage and Carruthers (Tetrahedron Lett., 22, 1859-1862, 1981), or by the triester method according to Matteucci, et al. (J. Am. Chem. Soc., 103, 3185, 1981), both incorporated herein by reference, or by other chemical methods such as using a commercial automated oligonucleotide synthesizer. Typically, oligonucleotides are single-stranded, but double-stranded or partially double-stranded oligos may also be used in certain embodiments of the invention. An “oligo pair” is a pair of oligos that specifically bind to one another (i.e., are complementary (e.g., perfectly complementary) to one another).

The term “capture-associated oligo” refers to an oligo that is associated (or was previously associated, e.g., during a capture reaction) with a capture moiety (whether, e.g., conjugated to the capture moiety directly or via a loaded scaffold, for example). Conjugation to the capture moiety (or scaffold) may be at the 3′ or 5′ end of the capture-associated oligo. The term “electrode-associated oligo” refers to an oligo that is associated with an electrode. Association to the electrode may occur at the 3′ or 5′ end, but typically occurs at the 5′ end. In most embodiments of the present invention, an oligo pair comprises a capture-associated oligo and an electrode-associated oligo that are complementary or perfectly complementary to each other.

The term “universal oligo” generally refers to one oligo of an oligo pair, where each oligo in the pair has been rationally designed to have low complementarity to sequences that may be present in a sample. In certain preferred embodiments, the universal oligos in a universal oligo pair are perfectly complementary to one another. For example, a universal oligo for diagnosis of hepatitis using a human blood sample would be one with low complementarity to human genomic sequences, genomic sequences from hepatitis viruses, as well as genomic sequences of organisms that associate with humans (e.g., human gut flora (Enterococcus faecalis, Enterobacteriaceae, etc.), Candida albicans, Staphylococcus epidermidis, Streptococcus salivarius, Lactobacillus sp., Spirochetes, etc.) For a soil sample, a universal oligo would be one with minimal complementarity to genomic sequences from, e.g., soil flora and fauna. The term “capture-associated universal oligo” refers to a universal oligo that is associated (or was previously associated, e.g., during a capture reaction) with a capture moiety (whether, e.g., conjugated to the capture moiety directly or via a loaded scaffold, for example). The term “electrode-associated universal oligo” refers to a universal oligo that is associated with an electrode. In most embodiments of the present invention, a universal oligo pair comprises a capture-associated universal oligo and an electrode- or chip-associated universal oligo that are complementary (e.g., perfectly complementary) to each other.

The terms “complementary” and “complementarity” refer to oligonucleotides related by base-pairing rules. Complementary nucleotides are, generally, A and T (or A and U), or C and G. For example, for the sequence “5′-AGT-3′,” the perfectly complementary sequence is “3′-TCA-5′.” Methods for calculating the level of complementarity between two nucleic acids are widely known to those of ordinary skill in the art. For example, complementarity may be computed using online resources, such as, e.g., the NCBI BLAST website (ncbi.nlm.nih.govlblast/producttable.shtml) and the Oligonucleotides Properties Calculator on the Northwestern University website (basic.northwestern.edulbiotools/oligocalc.html). Two single-stranded RNA or DNA molecules may be considered substantially complementary when the nucleotides of one strand, optimally aligned and with appropriate nucleotide insertions or deletions, pair with at least about 80% of the nucleotides of the other strand, usually at least about 90% to 95%, and more preferably from about 98 to 100%. Two single-stranded oligonucleotides are considered perfectly complementary when the nucleotides of one strand, optimally aligned and with appropriate nucleotide insertions or deletions, pair with 100% of the nucleotides of the other strand. Alternatively, substantial complementarity exists when a first oligonucleotide will hybridize under selective hybridization conditions to a second oligonucleotide. Selective hybridization conditions include, but are not limited to, stringent hybridization conditions. Selective hybridization occurs in one embodiment when at least about 65% of the nucleic acid monomers within a first oligonucleotide over a stretch of at least 14 to 25 monomers pair with a perfectly complementary monomer within a second oligonucleotide, preferably at least about 75%, more preferably at least about 90%. See, M. Kanehisa, Nucleic Acids Res. 12, 203 (1984), incorporated herein by reference. For shorter nucleotide sequences selective hybridization occurs when at least about 65% of the nucleic acid monomers within a first oligonucleotide over a stretch of at least 8 to 12 nucleotides pair with a perfectly complementary monomer within a second oligonucleotide, preferably at least about 75%, more preferably at least about 90%. Stringent hybridization conditions will typically include salt concentrations of less than about 1 M, more usually less than about 500 mM and preferably less than about 200 mM. Hybridization temperatures can be as low as 5° C., and are preferably lower than about 30° C. However, longer fragments may require higher hybridization temperatures for specific hybridization. Hybridization temperatures are generally at least about 2° C. to 6° C. lower than melting temperatures (Tₘ), which are defined below.

A “capture moiety” refers to a molecule or a portion of a molecule that can be used to preferentially bind and separate a molecule of interest (a “target agent”) from a sample. The term “capture moiety” as used herein refers to any molecule, natural, synthetic, or recombinantly-produced, or portion thereof, with the ability to bind to or otherwise associate with a target agent in a manner that facilitates detection of the target agent in the methods of the present invention. For example, in certain embodiments the binding affinity of the capture moiety is sufficient to allow collection, concentration, or separation of the target agent from a sample. Suitable capture moieties include, but are not limited to nucleic acids, antibodies, antigen-binding regions of antibodies, antigens, epitopes, cell receptors (e.g., cell surface receptors) and ligands thereof, such as peptide growth factors (see, e.g., Pigott and Power (1993), The Adhesion Molecule Facts Book (Academic Press New York); and Receptor Ligand Interactions: A Practical Approach, Rickwood and Hames (series editors) Hulme (ed.) (IRL Press at Oxford Press NY)). Similarly capture moieties may also include but are not limited to toxins, venoms, intracellular receptors (e.g., receptors which mediate the effects of various small ligands, including steroids, hormones, retinoids and vitamin D, peptides) and ligands thereof, drugs (e.g., opiates, steroids, etc.), lectins, sugars, oligosaccharides, other proteins, phospholipids, and structured nucleic acids such as aptamers and the like. Those of skill in the art readily will appreciate that molecular interactions other than those listed above are well described in the literature and may also serve as capture moiety/target agent interactions. In certain embodiments, capture moieties are associated with scaffolds, and in other embodiments capture moieties are conjugated to capture-associated oligos.

The terms “preferential binding,” “specific binding,” “preferential association,” “specific association,” and the like refer to a specific interaction between a first and second molecule that occurs at least 20 times or more, preferably 50 times or more, more preferably 100 times or more, and even 1000 times or more often than a nonspecific binding event between the first molecule and a molecule that is not the second molecule. For example, a capture moiety can be designed to preferentially bind to a given target agent at least 20 times or more, preferably 50 times or more, more preferably 100 times or more, and even 1000 times or more often than to other molecules in a biological solution. While not wishing to be limited by applicants present understanding of the invention, it is believed binding will be recognized as existing when the Kₐ is at 10⁷ l/mole or greater, preferably 10⁸ l/mole or greater. In the embodiment where the capture moiety is comprised of antibody, the binding affinity of 10⁷ l/mole or more may be due to (1) a single monoclonal antibody (e.g., large numbers of one kind of antibody) or (2) a plurality of different monoclonal antibodies (e.g., large numbers of each of several different monoclonal antibodies) or (3) large numbers of polyclonal antibodies. It is also possible to use combinations of (1)-(3). The differential in binding affinity may be accomplished by using several different antibodies as per (1)-(3) above and as such some of the antibodies in a mixture could have less than a four-fold difference. For purposes of most embodiments of the invention an indication that no binding occurs means that the equilibrium or affinity constant Kₐ is 10⁶ l/mole or less. Antibodies may be designed to maximize binding to the intended antigen by designing peptides to specific epitopes that are more accessible to binding, as can be predicted by one skilled in the art.

A “target agent” is a molecule of interest in a sample that is to be detected by the devices and methods of the instant invention. For example, in certain embodiments the target agent is captured through preferential binding with a capture moiety. In one such embodiment, the capture moiety is an antibody and the target agent is any molecule which contains an epitope against which the antibody is generated, or an epitope specifically bound by the antibody. In another embodiment, the capture moiety is a protein specifically bound by an antibody, and the antibody itself is the target agent. Target agents also may include but are not limited to receptors (e.g., cell surface receptors) and ligands thereof, nucleic acids, intracellular receptors (e.g., receptors which mediate the effects of various small ligands, including steroids, hormones, retinoids and vitamin D, peptides) and ligands thereof, metabolites, steroids, hormones, lectins, sugars, oligosaccharides, proteins, phospholipids, toxins, venoms, drugs (e.g., opiates, steroids, etc.), and the like. Those of skill in the art readily will appreciate that molecular interactions other than those listed above are well described in the literature and may also serve as capture moiety/target agent interactions.

The term “sample” in the present specification and claims is used in its broadest sense and can be, by non-limiting example, any sample that is suspected of containing a target agent(s) to be detected. It is meant to include specimens or cultures (e.g., microbiological cultures), and biological and environmental specimens as well as non-biological specimens. Biological samples may comprise animal-derived materials, including fluid (e.g., blood, saliva, urine, lymph, etc.), solid (e.g., stool) or tissue (e.g., buccal, organ-specific, skin, etc.), as well as liquid and solid food and feed products and ingredients such as dairy items, vegetables, meat and meat by-products, and waste. Biological samples may be obtained from, e.g., humans, any domestic or wild animals, plants, bacteria or other microorganisms, etc. Environmental samples can include environmental material such as surface matter, soil, water (e.g., contaminated water), air and industrial samples, as well as samples obtained from food and dairy processing instruments, apparatus, equipment, utensils, disposable and non-disposable items. These examples are not to be construed as limiting the sample types applicable to the present invention. Those of skill in the art would appreciate and understand the particular type of sample required for the detection of particular target agents (Pawliszyn, J., Sampling and Sample Preparation for Field and Laboratory, (2002); Venkatesh Iyengar, G., et al., Element Analysis of Biological Samples: Principles and Practices (1998); Drielak, S., Hot Zone Forensics: Chemical, Biological, and Radiological Evidence Collection (2004); and Nielsen, D. M., Practical Handbook of Environmental Site Characterization and Ground-Water Monitoring (2005)).

The term “antibody” as used herein refers to an entire immunoglobulin or antibody or any fragment of an immunoglobulin molecule which is capable of specific binding to a target agent of interest (an antigen). Examples of such antibodies include complete antibody molecules, antibody fragments, such as Fab, F(ab′)₂, CDRS, V_{L}, V_{H}, and any other portion of an antibody which is capable of specifically binding to an antigen. An IgG antibody molecule is composed of two light chains linked by disulfide bonds to two heavy chains. The two heavy chains are, in turn, linked to one another by disulfide bonds in an area known as the hinge region of the antibody. A single IgG molecule typically has a molecular weight of approximately 150-160 kD and contains two antigen binding sites. An F(ab′)₂ fragment lacks the C-terminal portion of the heavy chain constant region, and has a molecular weight of approximately 110 kD. It retains the two antigen binding sites and the interchain disulfide bonds in the hinge region, but it does not have the effector functions of an intact IgG molecule. An F(ab′)₂ fragment may be obtained from an IgG molecule by proteolytic digestion with pepsin at pH 3.0-3.5 using standard methods such as those described in Harlow and Lane, supra. Preferred antibodies for assays of the invention are immunoreactive or immunospecific for, and therefore specifically and selectively bind to, a protein (antigen) of interest and are not limited to the G class of immunoglobulin used in the above cited example. A “purified antibody” refers to that which is sufficiently free of other proteins, carbohydrates, and lipids with which it is naturally associated to measure any difference.

A substance is commonly said to be present in “excess” or “molar excess” relative to another component if that component is present at a higher molar concentration than the other component. Often, when present in excess, the component will be present in at least a 10-fold molar excess and commonly at 100-1,000,000 fold molar excess. Those of skill in the art would appreciate and understand the particular degree or amount of excess preferred for any particular reaction or reaction conditions. Such excess is often empirically determined and/or optimized for a particular reaction or reaction conditions.

The term “reacted capture-associated oligo” or “reacted capture-associated universal oligo” is commonly used in reference to capture-associated oligos or capture-associated universal oligos, respectively, associated with a capture moiety for a particular target agent, where the capture moiety has bound to the target agent, e.g., due to the presence of the target agent in a sample contacted with the capture moiety. The term “unreacted capture-associated oligo” or “unreacted capture-associated universal oligo” is used in reference to capture-associated oligos or capture-associated universal oligos, respectively associated with a capture moiety for a particular target agent, where the capture moiety has not bound to the target agent, e.g., due to a deficiency of the target agent in a sample contacted with the capture moiety.

The term “capture reaction” is commonly used in reference to the mixing/contacting of capture-associated oligos associated with a capture moiety and a sample under conditions that allow the capture moiety to attach to, bind or otherwise associate with a target agent in the sample. In certain embodiments, a capture reaction can involve immobilization of a target agent onto a matrix through binding to an immobilized binding partner on the matrix.

The term “melting temperature” or Tₘ is commonly defined as the temperature at which half of the population of double-stranded nucleic acid molecules becomes dissociated into single strands. The equation for calculating the Tₘ of nucleic acids is well known in the art. As indicated by standard references, a simple estimate of the Tₘ value may be calculated by the equation: Tₘ=81.5+16.6(log₁₀[Na⁺])0.41(%[G+C])−675/n−1.0 m, when a nucleic acid is in aqueous solution having cation concentrations of 0.5 M, or less, the (G+C) content is between 30% and 70%, n is the number of bases, and m is the percentage of base pair mismatches (see e.g., Sambrook J et al., “Molecular Cloning, A Laboratory Manual,” 3d Edition, Cold Spring Harbor Laboratory Press (2001)). Other references include more sophisticated computations, which take structural as well as sequence characteristics into account for the calculation of Tₘ.

The term “matrix” means any surface. For example, “matrix” can refer to an electrode, or to a substrate comprising a plurality of electrodes, or beads or particles on which an immobilized binding agent is immobilized.

A “restriction endonuclease” is any enzyme capable of recognizing a specific sequence on a double- or single-stranded polynucleotide and cleaving the polynucleotide at or near the site. Examples of site-specific restriction endonucleases, the nucleotide sequences recognized by them, and their products of cleavage are well known to those of ordinary skill in the art and are available, e.g., in the 2006 New England Biolabs, Inc. catalog, including the 2006 New Products Catalog Supplement, which is incorporated herein by reference.

It should be understood by those skilled in the art that terms such as “target”, “agent”, “moiety”, “antigen”, “antibody”, “molecule,” and the like should be interpreted in the context in which they appear, and should be given the broadest interpretation possible unless specifically indicated otherwise.

### DETAILED DESCRIPTION

The present invention relates to an electrochemical device capable of detecting the presence of target agents in a sample that can be, for example, potentially infectious or disease-causing agents, chemical or biological toxins, pathogenic agents, drugs, drug metabolites, other metabolites, environmental contaminates, and the like, or a combination thereof. For additional information, see U.S. Ser. No. 60/801,950, filed May 19, 2006, entitled “Alternative Methods of Electrochemically Detecting One or More Target Agents,” U.S. Ser. No. 60/802,002, filed May 19, 2006, entitled “Alternative Methods of Electrochemically Detecting One or More Target Agents,” U.S. Ser. No. 60/801,703, filed May 19, 2006, entitled “Alternative Methods of Electrochemically Detecting One or More Target Agents,” U.S. Ser. No. 60/802,049, filed May 19, 2006, entitled “Methods of Electrochemically Detecting and Quantifying One or More Target Agents,” U.S. Ser. No. 60/802,039, filed May 19, 2006, entitled “Methods of Electrochemically Detecting One or More Amplified Target Agents,” U.S. Ser. No. 11/703,103, filed Feb. 7, 2007, entitled “Device and Methods for Detecting and Quantifying One or More Target Agents; U.S. Ser. No. 60/802,950, filed May 24, 2006, entitled “Small Disposable Detection Device and Methods of Use Thereof;” U.S. Ser. No. 60/802,964, filed May 24, 2006, entitled “Electrochemical Detection Device with Reduced Footprint;” and U.S. Ser. No. 60/815,106, filed Jun. 20, 2006, entitled “Electrochemical Detection Device with Reduced Footprint,” all filed by Antara BioSciences Inc. and incorporated by reference herein in their entireties for all purposes.

Device

The present invention provides an electrochemical detection device for detecting a target agent in a sample. The electrochemical detection device of the present invention has a reduced size and footprint compared to certain devices currently known in the art, is inexpensive, is simple to install, is easy to operate, yet provides a fast, effective, consistent result. Moreover, the accuracy of the result obtained using the present device is unaffected by the level of medical training and/or laboratory skills of the user. The elements in the various embodiments of the detection device shown in the figures are numbered consistently, so a given element may have the same number in multiple figures, even if specific characteristics of that element are different between different figures.

The electrochemical device of the present invention comprises a chassis to provide a supporting framework for various components of the device. For example, the chassis can provide a support on which to attach, directly or indirectly, certain components of a fluidics system (e.g., one or more valves, pumps, fluidics ports/paths, air intake ports/paths, high pressure lines, reagent manifolds, reagent draw tubes, reagent reservoirs/chambers, sample collection elements, seals, filtered flow channels, plungers, or a combination thereof), a thermal system (e.g., one or more cooling means, heating means, temperature monitoring means, or a combination thereof), and an electronics system (e.g., one or more circuit boards, power supplies, electrical connections, wired interfaces, wireless interfaces, custom integrated circuits, sensors, electrodes, ports, pass-throughs, channels, indicator lights, or a combination thereof). In certain embodiments, such supporting framework comprises, for example, one or more pass-throughs, manifolds, mounts, ports, apertures, cavities, or a combination thereof.

In certain embodiments, a chassis is a fluidics monoblock. A fluidics monoblock may be machined, or injection molded and glued or ultrasonically welded to make fluid-tight channels without the need for internal tubing and fittings. A fluidics monoblock may be manufactured from materials including plastic or glass, or more preferably, but not limited to, acrylonitrile butadiene styrene (ABS), polyvinyl chloride (PVC), polycarbonate, acrylic (e.g., PMMA (polymethyl methacrylate)), or any compatible and solvent-bondable material, though any material would suffice as long as the fluid contact surfaces are biocompatible or coated to be biocompatible. If a chassis is not a fluidics monoblock, it can comprise any material, such as plastic or metal, where the fluid paths of a fluidics monoblock embodiment are replaced by point-to-point tubing with the appropriate fittings and mountings, etc.

In certain embodiments, a fluidics system (in some embodiments termed a “chemistry module”) of the instant invention comprises fluid paths to guide the flow of liquids and air within and without the device. The fluid paths can be round or non-round, and their lengths are typically minimized to reduce reagent consumption, wash volumes and hazardous waste volume. The fluidics system can also comprise a syringe drive (e.g., a dry syringe drive kept separate from process chemistry), and in such embodiments the chassis may comprise screw holes for mounting the syringe drive on the device. In certain embodiments, the channels are hydrophobic in order to reduce volume loss on the sides of the channels. The fluid paths may comprise one or more (i) high pressure lines (e.g., on the pressure side of a pump connecting at least one of the fluidic interface ports to a pump aperture); (ii) reagent manifolds (e.g., connecting a pump aperture to at least one valve mount); (iii) air intake paths (e.g., connecting an air intake port to at least one valve mount); (iv) waste paths (e.g., connecting a fluid interface port to a reagent draw tube, where instead of drawing reagent from a reagent reservoir, the reagent draw tube delivers waste to a reagent reservoir (i.e., one reagent draw tube serves as a waste outlet)); (v) means (e.g., ports) to connect with reagent draw tubes; or a combination thereof. In certain embodiments, a plurality of valve mounts are connected in sequential order to the pump aperture via a reagent manifold. In certain embodiments, valves are arranged in a sequential layout, in alternative embodiments, valves are arranged in a non-sequential layout such as a star configuration, and in further embodiments, the valves may be arranged in a layout comprising both sequential and non-sequential placements.

In certain embodiments, a fluidics system of the instant invention comprises a pump, for example, but not limited to, a peristaltic pump, a syringe-type pump, a pipette-type or “dry seal” pump, a gear pump, or a diaphragm pump. A peristaltic pump has a pump motor that turns a pump rotor. A pump housing provides a support on which to mount a pump motor and pump rotor, as well as providing a reaction load for a peristaltic tube. In certain embodiments, an aperture in the device accommodates the pump. A syringe-type pump has a pump motor that moves a linear shaft comprising a seal within a barrel, which can come into contact with a fluid being pumped. A pipette-type pump is similar to a syringe-type pump in that it has a pump motor that moves a linear shaft within a barrel; however, in a pipette-type pump the seal is associated with the barrel rather than the linear shaft. One feature of this design is that the seal typically stays dry, which is not generally the case with a syringe-type pump. Keeping the seal dry is advantageous for a number of reasons, including reduced maintenance costs. For example, a liquid sample may contain salts which can be corrosive to the seal. To deal with this problem, a user would have to either carefully clean the pump between uses, or replace the seal or the entire pump as it becomes nonfunctional. In certain embodiments of the invention, the seal in the pump is a spring-actuated seal, certain examples of which are produced by Bal Seal Engineering, Inc. (Foothill Ranch, Calif.).

In certain embodiments, a fluidics system of the instant invention comprises valves, in one embodiment, solenoid valves, each comprising a cylinder with two holes disposed on one end, where three valves connect the reagent manifold to the reagent draw tubes and ultimately reagent reservoirs, while the remaining valve is an air intake valve which plumbs from the reagent manifold to the air intake path. In alternative embodiments, rotary valves, shear valves, pneumatically activated valves, pinch valves, and the like (or discrete valves in a point-to-point plumbing environment) may replace the solenoid valves.

In certain embodiments, a fluidics system of the instant invention comprises reagent reservoirs, which may be vials, bottles, tubes, bags, or pouches, and may be discrete entities or molded as a single unit and may be composed of glass, metal, plastic, or virtually any other material as long as it is material that can hold but does not react with the reagents and/or waste. In addition, the reagent reservoirs may be small in size in a single-use configuration, or may be connected to large reservoirs for multiple-use environments. Reagent reservoirs may be separate from one another, or a single piece component may comprise multiple reagent reservoirs. Similarly, reagent draw tubes may be separate or clustered. In certain embodiments, a fluidics system of the instant invention comprises a one-piece molded single-use reagent pack including a waste vial that may be switched out and replaced with another reagent pack quickly and easily. Typically, the reagent reservoirs hold reagents for processing and electrochemical detection of a sample, but do not hold the sample itself. However, in certain embodiments, a reagent reservoir could be used to hold a sample prior to electrochemical detection.

In certain embodiments, a fluidics system of the instant invention comprises one or more filtered flow channels. A filtered flow channel may comprise a filter that works by physical means (through pores) or chemical means (for example, antibody/antigen pairs). A filter of a filtered flow channel may comprise sintered metal, natural or synthetic porous ceramic, or fibrous material such as paper or plastic. The filter element itself could comprise a reagent coating, so that any solution passing through the filter is exposed to the reagent; for example, the electrochemical reagent could be coated on the filtered flow channel, in some embodiments eliminating the need for an electrochemical reagent chamber and an electrochemical reagent port.

In certain embodiments, a fluidics system of the instant invention comprises a plunger, for example, to deliver reagents within the device. For example, a plunger may be used to deliver one or more reagents from reagent chambers and/or reservoirs. Alternative embodiments may employ a form of stored energy, such as compressed air or a CO₂ cartridge. Essentially, a plunger is used to move reagents, sample solutions, and/or the other reagents around the device. One skilled in the art would recognize that there are alternative means for doing so, such as a bladder, hand crank, small electric motor (such as those employed in pagers or cellular phones), and the like.

In certain embodiments, a thermal system of an electrochemical detection device of the present invention comprises a cooling means, a heating means, a temperature monitoring means, or a combination thereof. For example, a cooling means may comprise a heat sink and a fan, and a heating means may comprise a heater, e.g., attached to a bottom surface of the heat sink. In certain embodiments, the heat sink is a movable heat sink having a bottom surface to which a heater, in one embodiment, a Minco™ heater, is attached. In operation, the heater contacts the electrochemical detection chip, sandwiching the heater between the heat sink and electrochemical detection chip. A fan mounted to the chassis blows onto the heat sink. In the embodiments shown throughout the figures, a fan is shown, however, a blower or other cooling device could be used in alternative embodiments. The heat sink can be constructed of any metal, particularly aluminum or copper, and can be of any useful configuration as long as the surface area is adequate to dissipate heat in the system. Various different types of heat sinks are well known to those of ordinary skill in the art, such as finned and block heat sinks. As an alternative to a fan configuration, a liquid-cooled system or heat pipe may be used. In certain embodiments, a Minco™ heater is disposed on the bottom surface of heat sink; however, any appropriate heater may be used, such as but not limited to other types of film-type heaters, a thermoelectric cooler or peltier device, a resistive heater, a cartridge heater, a Kapton heater, a rubber heater, a wire heater, a trace heater, or a thermoelectric module (e.g., a TEC heater). Typically, a temperature monitoring means comprises a thermal sensor to provide feedback on the temperature of the heater. Different types of temperature monitoring means are well known to those of ordinary skill in the art, and may measure temperature in real time or may determine an appropriate amount of electricity to pass to the heater to achieve a desired temperature, for example, by using an equation (e.g., V=ir) and a look-up table. For example, temperature monitoring means that may be used in an electrochemical detection device of the present invention include, but are not limited to, thermistors, thermocouples, and RTDs. Such temperature monitoring means is preferably incorporated into the heater itself, but may also be positioned elsewhere, such as within an electrochemical detection chip. In related embodiments, a thermal system of an electrochemical detection device of the present invention further comprises an insulator and/or a compliance element between a heater and a heat sink. An insulator would serve to slow the flow of heat into the heat sink, and a compliance element would ensure that the heater was appropriately positioned against the electrochemical detection chip, as well as providing some level of insulation. Insulators and compliance elements are well known and readily available to those of ordinary skill in the art.

In some embodiments, an electrochemical device of the present invention comprises an electronics system comprising one or more circuit boards (e.g., a control board, an electrical board, a processing board, or a board comprising a combination thereof). For example, in certain embodiments a circuit board termed a “control board” can electrically and logically connect to one or more pump motors; heaters (not shown, but disposed on bottom surface of heat sink in the embodiments in the figures); thermal sensors; fans; valves; power supplies; computers; other circuit boards (e.g., a processing board or an electrical board); or a combination thereof. A processing board comprises an electrical interface that can connect an electrochemical detection chip (for example, through an electrical interface that passes through a pass-through in the chassis of the electrochemical detection device) to an electrical board residing on a chassis of the device, e.g., in a cavity. The processing board can also connect to the control board, and may in some embodiments connect to a power supply. The configuration of the control boards, processing boards, and electrical boards disclosed herein is exemplary only. One skilled in the art could combine the boards into a single board, or further divide the boards into three or more boards. Further, elements of a processing board could be located in an electrochemical detection chip or an electrical board. In addition, the electronics system may comprise additional means for accommodating electrical connections (e.g., channels, pass-throughs, etc. in the chassis). In addition, the electronics system may comprise a custom integrated circuit. Further, the electronics system can comprise indicator lights, for example, simple LEDs (green for no target detected, red for target detected, for example), or, as an alternative, a single light can be used, or the results of the test may be stored within a memory of device for later downloading or other retrieval and/or analysis.

A power supply to provide power to the device can be, for example, a battery, a fuel cell, or an electricity generating mechanism such as a hand crank generator or an inductive moving-mass power generator. Alternatively, the device could comprise a means to plug into an electrical outlet, including but not limited to, a cigarette lighter outlet in an automobile or any outlet of standard voltage.

The instrument can be configured to communicate with other machines (such as a PC or other workstation) through a variety of wired and/or wireless interfaces. Each interface has a number of protocol options and implementations. Although the bandwidth required is relatively low, it is important that the communication be secure, reliable, robust and error-correcting. Wired communication protocols include but are not limited to serial connections (e.g., RS232), USB (v1.0, v1.1, v2.0), or Ethernet (IP), and wireless communication protocols include but are not limited to Bluetooth, wifi, or cellular networks. For connections that support TCP/IP stack (e.g., ethernet and wifi), an http server can be embedded in the instrument so that communication with the device is accessed through a web browser. Such interfaces may be configured to allow interactive or programmatic access to the current state of the instrument (e.g., running status, errors, etc.), changes in the state of the instrument (e.g., start run, changes in temperature, changes in pump speed, sample positioning, etc.), records on the logs of the machine (e.g., errors, etc.), perform diagnostic functions (e.g., self test, purge system, etc.), and gather result data (e.g., sample identification, probe read data, etc.)

In some embodiments, an electrochemical detection device of the instant invention is modular in design. For example, one or more of an electronics system, a thermal system, a fluidics system, or portions thereof can be easily swiched out and replaced quickly and easily. For example, rather than clean out all reagent reservoirs and replacing all the solutions in a first fluidics system for a new experiment, the first fluidics system can simply be removed and replaced with another already containing reagents required for the new experiment. Likewise, if there is a failure in the thermal system or electronics system, they (or portions thereof) could similarly be switched out without having to rebuild the entire device. In other embodiments, the device comprises a chemistry module and an electronics module.

An electrochemical device of the present invention can comprise an electrochemical detection chip, described in detail below. Briefly, an electrochemical detection chip useful with an electrochemical detection device typically comprise a passive circuit chip disposed within a cartridge or detection chamber. Oligos may be immobilized onto the surfaces, such as electrodes, directly or indirectly, by covalent bonding, ionic bonding and physical adsorption. To detect multiple target agents in a sample simultaneously, multiple electrodes, or an electrode with multiple nucleic acid molecules attached in a predetermined configuration can be employed. Additionally, to verify the hybridization to a particular nucleic acid molecule, the device comprising the electrodes preferably includes a switch circuit, a decoder circuit, and/or, a timing circuit to apply the voltage to the individual electrodes and to receive the output signal from each of the electrodes.

In some embodiments, the present device solves the problem of detection for a wide range of target agents by combining the versatility of target agent recognition with the speed and sensitivity of electrochemical nucleic acid detection, while in turn eliminating the need for nucleic acid isolation, amplification, and/or labeling, and the problems associated with non-specific nucleic acid hybridization. The non-specific hybridization observed in other DNA detection methods currently known in the art is overcome by using a sensor having only known nucleic acid sequences for hybridization (sequences that, in a preferred embodiment, are rationally-designed to minimize the risk of non-specific hybridization (e.g., universal oligos)), thereby ensuring that specific hybridization is optimized. Also, the single-stranded nucleic acids or oligos on the sensor employed in the present invention can be of many lengths and sequences, but preferably have lengths and sequences that prevent non-specific hybridization to one another, and prevent non-specific hybridization to sequences that may be present in the sample (e.g., human genomic sequences or genomic sequences from pathogens).

Chemistry

The device of the present invention is used to perform a series of chemical reactions. Briefly, one chemical component comprises at least one single-stranded nucleic acid molecule termed a “capture-associated oligo” that is conjugated to a “capture moiety” to create a “capture-associated oligo complex.” A capture moiety specifically associates with a target agent to be detected, thereby associating the capture-associated oligo conjugated thereto to the target agent. Capture moieties can be, for example, antibodies, antigens or other ligands specific for a particular target agent. Capture-associated oligo complexes are contacted/mixed with a sample that is suspected of containing one or more target agents under conditions that if a target agent is present, the capture moiety can react with, e.g., bind with/to the specific target agent. The capture-associated oligo complexes may be added in excess relative to the amount of target agent suspected to be present in the sample. The capture-associated oligos conjugated to capture moieties that bound a target agent are contacted with an electrochemical detection device, and a signal is generated indicating the presence of the target agent, e.g., in a biological sample. In some methods, a single capture-associated oligo complex (e.g., multiple identical capture-associated oligo complexes) is used to “capture” the target agent from, for example, a biological sample. In other embodiments, a plurality of different capture-associated oligo complexes are used to capture a plurality of different target agents simultaneously.

A “target agent” is a molecule of interest in a sample that is to be detected by the devices of the instant invention. For example, a target agent to be detected can be any target agent suspected of causing or capable of causing a pathological or otherwise observable or detectable condition in humans or animals, or can be environmental contaminants. Target agents can include, but are not limited to, bacteria, viruses, proteinaceous agents (such as prions), metabolites, biological agents and/or chemical agents. Again, those of skill in the art would appreciate and understand the particular type of target agent to be found in a particular sample and that is suspected of being related to a particular physiological condition or state. Other target agents that can be detected include air-borne, food-borne and water-borne agents, including biological and chemical toxins. In certain embodiments, as described above, the target agent is captured through preferential binding with a capture moiety. In one such embodiment, the capture moiety is an antibody and the target agent is any molecule which contains an epitope against which the antibody is generated, or an epitope specifically bound by the antibody. In another embodiment, the capture moiety is a protein specifically bound by an antibody, and the antibody itself is the target agent. Target agents also may include but are not limited to receptors (e.g., cell surface receptors) and ligands thereof, nucleic acids, intracellular receptors (e.g., receptors which mediate the effects of various small ligands, including steroids, hormones, retinoids and vitamin D, peptides) and ligands thereof, metabolites, steroids, hormones, lectins, sugars, oligosaccharides, proteins, phospholipids, toxins, venoms, drugs (e.g., opiates, steroids, etc.), and the like. Those of skill in the art readily will appreciate that molecular interactions other than those listed above are well described in the literature and may also serve as capture moiety/target agent interactions.

Conjugation of a capture-associated oligo to a capture moiety may be performed in numerous ways, providing it results in a capture moiety possessing both epitope-specific binding to capture the target agent, and providing it does not restrict nucleic acid hybridization functionalities in embodiments where a cleavage is not performed to allow detection of the bound target agent. For example, nucleic acid-antibody conjugates can be synthesized by using heterobifunctional cross-linker chemistries to covalently attach single-stranded DNA labels through amine or sulfhydryl groups on an antibody to create a capture agent of the invention. Hendricksen E R, Nucleic Acids Res. (1995) Feb. 11; 23(3):522-9. In another example, covalent single-stranded DNA-streptavidin conjugates, capable of hybridizing to complementary surface-bound oligonucleotides, are utilized for the effective immobilization of biotinylated capture moieties. Niemeyer C M, et al., Nucleic Acids Res. 2003 Aug. 15; 31(16):90. Many other nucleic acid molecular conjugates are described in Heidel J et al., Adv Biochem Eng Biotechnol. (2005); 99:7-39. Additional methods of creating capture moiety-nucleic acid conjugates, both those existing and under development, will be apparent to one skilled in the art upon reading the present disclosure, and such methods are intended to be captured within the methods of the invention.

The capture reaction (i.e., binding of target agent by a capture moiety or immobilized binding partner, e.g., an antibody binding reaction) is performed in solution, typically in a physiological buffer such as phosphate buffered saline (PBS) supplemented with a non-specific blocking agent, such as new-born calf serum, and may be used when the target agent to be detected is normally found under physiological conditions. However, the methods of the present invention are not limited to detecting target agents only found in physiological conditions. Those of skill in the art would appreciate and understand that different capture moieties may be used in different conditions without affecting the ability to bind the particular target agent to be detected.

The capture reaction can be performed at a temperature within the range of 0° C. to 100° C., preferably at a temperature between 2° C. and 40° C., and more preferably within the range of about 4° C. to about 37° C., and most preferably within the range of about 18° C. to about 25° C. The capture reaction is typically conducted from about 5 minutes to 12 hours, preferably from about 10 minutes to 6 hours, and more preferably from about 15 minutes to 1 hour. The duration of the capture reaction depends on several factors, including the temperature, suspected concentration of the target agent, ionic strength of the sample, and the like. For example, a capture reaction may require 15 minutes in length at a temperature of 18° C., or 30 minutes in length at a temperature of 4° C. Those of skill in the art would appreciate and understand the particular the specific time required for the reaction to be performed.

The capture moiety(ies) (e.g., conjugated to capture-associated oligos in capture-associated oligo complexes) can be provided in excess, with the excess (i.e., unreacted) capture moieties being removed prior to hybridization. This excess is typically determined relative to the suspected level of target agent present in the sample. This relative excess can be from about 1:1 to 1,000, 000:1, preferably 2:1 to about 10,000:1, and more preferably from about 4:1 to 1000:1, and most preferably from 5:1 to 100:1. For example, when the capture moiety is an antibody, typically, an excess of capture moiety can be created by adding 1 μg of the antibody conjugated oligonucleotide to a sample suspected of containing up to 1 million target agents to be detected. This ratio gives rise to a molar ratio of typically about 4:1, but can vary dependant upon the molecular mass of the antibody and the target agent to be detected.

As noted above, if an excess of capture-associated oligo complexes is added to the sample, unreacted capture-associated oligo complexes (i.e., capture-associated oligo complexes that did not bind to target agent) can be removed prior to contact of the remaining “reacted capture-associated oligo complexes” (or capture-associated oligos released therefrom) with an electrochemical detection device comprising oligos complementary to the capture-associated oligos (termed “electrode-associated oligos”). The removal of excess, unreacted capture-associated oligo complexes can be achieved by providing immobilized binding partner(s) that specifically bind to the unreacted capture-associated oligo complexes, e.g., by interacting with capture moieties that have not bound target agent. The immobilized binding partners can be affixed/immobilized directly or through a chemical linker to a matrix such as beads (including, but not limited to solid beads, semi-solid beads, porous beads, magnetic beads, or the like), or to other suitable surfaces. Those of skill in the art will readily understand the versatility of the nature of this immobilized binding partner. Essentially, any ligand and receptor can be utilized to serve as capture moieties, target agents and immobilized binding partners, as long as the target agent is appropriate for detection for the pathology or condition of interest. Suitable ligands and receptors include an antibody or fragment thereof to be recognized by a corresponding antigen or epitope, a hormone to be recognized by its receptor, an inhibitor to be recognized by its enzyme, a co-factor portion to be recognized by a co-factor enzyme binding site, a binding ligand to be recognized by its substrate, and the like.

For example, if the capture moiety is an antibody specific for a particular infectious agent (such as a bacterial or viral agent), the immobilized binding partner can be a naturally-occurring or synthetic epitope of the antigen with which the antibody recognizes and interacts in a specific manner. In another example, if the capture moiety is an antigen specific for a particular antibody, the immobilized binding partner can be a naturally-occurring or synthetic antibody or functional fragment thereof with which the antigen recognizes and interacts in a specific manner. If multiple capture-associated oligo complexes are used, each having a capture moiety specific for a different target agent or different epitope of the same target agent, the use of multiple immobilized binding partners facilitates the removal/separation of unreacted capture-associated oligo complexes. In such a detection method, multiple different target agents (e.g., agents specific to different viruses, bacteria, and/or strains or serovars thereof) may be screened/detected simultaneously.

As described herein, an immobilized binding partner is bound to a matrix, which may comprise macroscopic particles, such as Sephadex®, which can be used to construct a column with a filter, over which the mixture of reacted and unreacted capture-associated oligo complexes can be passed. Similarly, the matrix may include a suspension of particulate matter in a solution, such as microscopic and/or macroscopic beads/particles, where the immobilized binding partner is immobilized on the beads or particle. In some methods using particles, the unreacted capture-associated oligo complexes are filtered from the solution by passage through a filtered flow channel. Thus, only reacted capture-associated oligo complexes (i.e., capture-associated oligo complexes that bound the particular target agent) will be available for hybridization to electrode-associated oligos, e.g., in a sensor chamber.

Hybridization between a capture-associated oligo (whether associated with a reacted capture-associated complex or having been released therefrom) and an electrode-associated oligo is detected and serves as an indication of a presence of the target agent of interest, e.g., in a biological or environmental sample. When multiple capture-associated oligos—each conjugated to a specific capture moiety for a distinct target agent—are used, the sequences of the capture-associated oligos must be sufficiently different from one another to preclude the possibility of hybridizing to each other. Likewise, the sequences of each of the electrode-associated oligos must be sufficiently different from one another and specific for a given capture-associated oligo to preclude the possibility of hybridizing to another electrode-associated oligo, or to more than one capture-associated oligo. Those of skill in the art would appreciate and understand that this specific hybridization can be achieved in a number of ways, including, but not limited to, the use of specifically designed/predetermined sequences (e.g., universal oligo pairs, as disclosed in the patent applications cited above and incorporated herein by reference), varying the temperature at which the hybridization takes place, varying the concentration of certain constituents of the hybridization buffer, such as divalent and monovalent metal ions, by varying the length of the nucleic acid molecules, or a combination thereof. Further, in most embodiments, it is preferred to avoid unintended hybridization with sequences that may be found in the sample (e.g., human genomic sequences and genomic sequences of pathogens) in designing capture-associated and electrode-associated oligos.

For example, the oligos for use in the present invention can be 1 to 10,000 bases in length, preferably 10 to 1000 bases in length, more preferably 10-500 bases in length and more preferably about 25 to about 100 bases in length. Additionally, the oligos may be DNA, RNA or PNA (peptide nucleic acid) and can include non-naturally occurring subunits, sequences and/or moieties. PNA includes peptide nucleic acid analogs. The backbones of PNA are substantially non-ionic under neutral conditions, in contrast to the highly charged phosphodiester backbone of naturally-occurring nucleic acids. This results in at least two advantages. First, the PNA backbone exhibits improved hybridization kinetics. PNAs have larger changes in the melting temperature (Tₘ) for mismatched versus perfectly matched basepairs. DNA and RNA typically exhibit a 2-4° C. drop in Tₘ for an internal mismatch. With the non-ionic PNA backbone, the drop is closer to 7-9° C. This allows for better detection of mismatches. Similarly, due to their non-ionic nature, hybridization of the bases attached to these backbones is relatively insensitive to salt concentration. This is advantageous, as a reduced salt hybridization solution has a lower Faradaic current than a physiological salt solution (in the range of 150 mM).

In some embodiments, capture-associated oligos (as well as those complementary thereto, e.g., electrode-associated oligos) are oligos that have been rationally-designed to optimize specific hybridization and minimize non-specific hybridization (e.g., they are universal oligos). Briefly, the term “universal oligo” generally refers to one oligo of an oligo pair, where each oligo in the pair has been rationally designed to have low complementarity to sequences that may be present in a sample. In certain preferred embodiments, the universal oligos in a universal oligo pair are perfectly complementary to one another. For example, a universal oligo for diagnosis of hepatitis using a human blood sample would be one with low complementarity to human genomic sequences, genomic sequences from hepatitis viruses, as well as genomic sequences of organisms that associate with humans (e.g., human gut flora (Enterococcus faecalis, Enterobacteriaceae, etc.), Candida albicans, Staphylococcus epidermidis, Streptococcus salivarius, Lactobacillus sp., Spirochetes, etc.) For a soil sample, a universal oligo would be one with minimal complementarity to genomic sequences from, e.g., soil flora and fauna. The term “capture-associated universal oligo” refers to a universal oligo that is or was previously associated with a capture moiety (whether, e.g., conjugated to the capture moiety directly or via a loaded scaffold, for example). The term “electrode-associated universal oligo” refers to a universal oligo that is associated with an electrode. Further description and examples of universal oligos, as well as methods for identifying one or more universal oligo pairs are provided in the patent applications listed above, which are incorporated herein by reference.

A hybridization reaction performed before electrochemical detection is typically performed in solution where the metal ion concentration of the buffer is between 0.01 mM to 5 M and the pH range is from pH 5 to pH 10. In certain embodiments, such solution would be included in a reagent reservoir of an electrochemical detection device of the present invention. Other components can be added to a buffer to promote hybridization such as dextran sulfate, EDTA, surfactants, etc. A hybridization temperature typically is within the range of 10° C. to 90° C., preferably at a temperature within the range of 25° C. to 60° C., and most preferably at a temperature within the range of 30° C. to 50° C. Alternatively, a temperature is chosen relative to the Tₘ's of the nucleic acid molecules employed. In certain embodiments, a hybridization reaction is performed at an elevated temperature where the heat is provided by a heater, e.g., attached to a bottom surface of a heat sink of an electrochemical detection device of the present invention. A hybridization reaction is typically performed at an incubation time from 10 seconds to about 12 hours, and preferably an incubation time from 30 seconds to 5 minutes. A variety of hybridization conditions may be used in the present invention, including high, moderate and low stringency conditions; see for example Maniatis et al., Molecular Cloning: A Laboratory Manual, 3rd Edition (2001), hereby incorporated by reference. Persons of ordinary skill in the art will recognize that stringent conditions are sequence-dependent and are dependent upon the totality of the conditions employed. Longer sequences typically hybridize specifically at higher temperatures. Generally, stringent conditions are selected to be about 5-10° C. lower than the thermal melting point (Tₘ) for the specific sequence at a defined ionic strength pH. Stringent conditions are those in which the salt concentration is less than about 1.0 M sodium ion, typically about 0.01 to 1.0 M sodium ion concentration (or other salts) at pH 7.0 to 8.3 and the temperature is at least about 30° C. for short probes (e.g., 10 to 50 nucleotides) and at least about 60° C. for long probes (e.g., greater than 50 nucleotides). Stringent conditions may also be achieved with the addition of destabilizing agents such as formamide. Hybridization conditions may also vary when a non-ionic backbone, e.g., PNA, is used. Certain advantages of using PNA are discussed above. A hybridization reaction can also be controlled electrochemically by applying a potential to the electrodes to speed up the hybridization. Alternatively, the potential can be adjusted to ensure specific hybridization by increasing the stringency of the conditions.

With these concepts in mind, in one application of one embodiment of the invention, oligos are conjugated to antibodies and the target agent of interest is an antigen. In accordance with this embodiment the invention, the following elements are included: (1) a first single-stranded nucleic acid molecule immobilized on a surface, where the surface comprises an electrode, (2) a first reagent comprising capture-associated oligo complexes, which comprise a second single-stranded nucleic acid molecule that is complementary to the first single-stranded nucleic acid molecule conjugated to a capture moiety that specifically binds to the target agent, (3) a second reagent comprising immobilized binding partners, and (4) a sample suspected of containing the target antigen. In one aspect, the first reagent is mixed with the sample to form a first mixture, and the first mixture is mixed with the second reagent. The unreacted capture-associated oligo complexes are captured by the immobilized binding partners, thereby removing the unreacted capture-associated oligo complexes from solution. In certain embodiments, the solution phase of the mixture is filtered (e.g., through a filtered flow channel), and electrochemical detection is performed as otherwise described herein (e.g., after transfer into a sensor chamber). Other variations on this preferred embodiment include one or more other aspects of the invention described herein or such other modification known to those of ordinary skill in the art. This embodiment may be employed in a multi-target (so-called multiplexed) format, thereby allowing for the screening of multiple target agents simultaneously.

An advantage of a simultaneous accurate detection method includes an increased speed at which multiple suspected target agents can be eliminated. For example, a patient can provide a sample that can quickly be tested for the presence of multiple suspected target agents (e.g., toxins, strains of bacteria and/or viruses, etc.) Such a rapid and accurate test can aid in the treatment of a condition, e.g., where no bacterial infection is found there is no need to treat with antibiotics. Similarly, improper use of antibiotics can be reduced or eliminated by ensuring that the proper antibiotic, specific for the detected infectious agent, is administered. Likewise, the cause of potential food-poisoning outbreaks, or terrorist attacks can be ascertained in a short space of time, and the relevant treatment regimen implemented, e.g., antibiotics for bacterial causes, antivirals for viral causes, and chemical antidotes for toxin causes. Additionally, the construction of complete test panels that can be specific for the particular type of sample, or for the particular suspected underlying diseases or agents is another advantage of this particular method. For example, one could construct a test panel for sexually-transmitted diseases, another panel for common blood-borne diseases, yet another for airborne pathogens, yet another for terrorist agents (biological and/or chemical), yet another for common childhood disease. These are only representative examples of possible test panels and are not intended to limit the scope of the invention in any way. Those of skill in the art would appreciate and understand the particular pathogens/agents and combinations that could be used in a particular test panel.

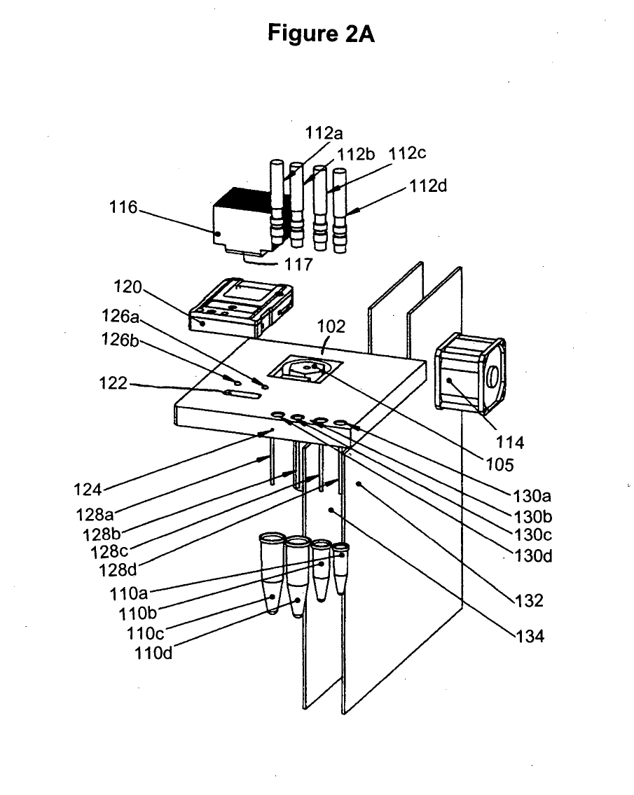

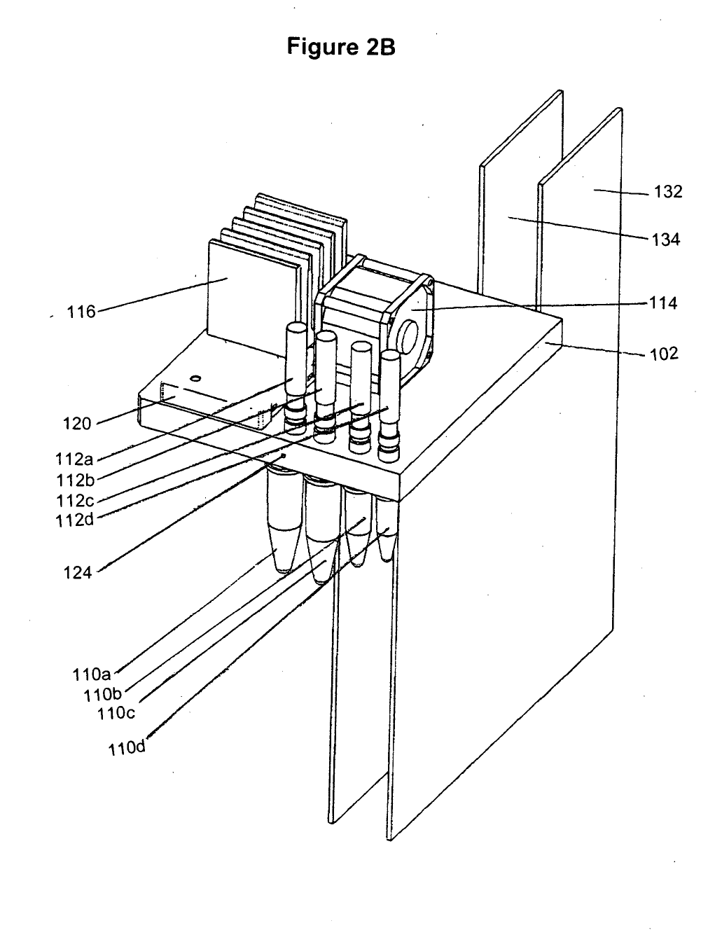

In some embodiments of the invention, cleavage of capture-associated oligos from reacted capture-associated oligo complexes following separation and removal of unreacted capture-associated oligo complexes is performed prior to hybridization of the capture-associated oligos to electrode-associated oligos. In some such embodiments, the target agent does not come into contact with an electrochemical detection device. Such embodiments may be preferred when a capture moiety conjugated to a capture-associated oligo may interfere with hybridization or electrochemical detection of the capture-associated oligo, for example, because of the physical size or the presence of local areas of electron density on the surface of the capture moiety. One embodiment of a device of the present invention that would be appropriate for use in a method that involves an added cleavage step is shown in FIG. 2 where a second reaction chamber (42), an enzyme chamber (44) and an enzyme port (46) are present. Cleavage can be achieved by, for example, a digestive enzyme, i.e., an enzyme that causes hydrolysis of a bond in a molecule, (e.g., proteolytic enzymes, lipases, phosphatases, phosphodiesterases, esterases, etc.), endonucleases, exonucleases, a restriction endonuclease (e.g., EcoRI), or a flap endonuclease (e.g., FEN-1, RAD2, XPG, etc.). The choice of cleavage method will depend on the nature of the conjugation of the capture moiety to the capture-associated oligo, as well as the capture moiety itself. For example, photocleavage may be employed where a photocleavable phosphoramidite is used in lieu of a restriction site. Those of skill in the art will readily appreciate and understand the circumstances under which one particular method of cleavage would be preferred over another method of cleavage.

For example, a digestive enzyme, such as trypsin, can be used when the antibody is conjugated to the capture-associated oligo through some peptide linkage; a restriction endonuclease can be used when there is a specific sequence present in the capture-associated oligo that is susceptible to the particular restriction endonuclease between the portion of the capture-associated oligo that is complementary to the electrode-associated oligo and the portion of the capture-associated oligo that is conjugated to the capture moiety. In preferred embodiments, restriction sites and restriction endonucleases are chosen to allow cleavage of single-stranded nucleic acids. Likewise, a flap endonuclease, such as RAD2, or XPG, could be used when there is a specific structure present in the capture-associated oligo that is susceptible to the particular flap endonuclease between the portion of the capture-associated oligo that is complementary to the electrode-associated oligo and the portion of the capture-associated oligo that is conjugated to the capture moiety. Those of skill in the art would appreciate and understand the particular types of structure susceptible to flap endonuclease cleavage.

Where it is intended that a restriction endonuclease will be used to separate the capture moiety from the capture-associated oligo, the capture-associated oligo will be engineered to contain a specific restriction site between the portion of the capture-associated oligo that is complementary to the electrode-associated oligo and the portion of the capture-associated oligo that is conjugated to the capture moiety. This restriction site will be designed, and the appropriate restriction endonuclease selected, to cleave only in the portion of the capture-associated oligo that is conjugated to the capture moiety and not in the region of complementarity to the electrode-associated oligo. In the case where multiple capture-associated oligo complexes are used simultaneously in a detection method, the capture-associated oligos will each contain a restriction site that is not present in the sequence of any of the other capture-associated oligos used for that detection method.

In certain embodiments where such cleavage is performed, the cleavage reaction is performed after the capture reaction has been completed and after separation of the immobilized phase of the first mixture is separated from the solution phase, e.g., by passage through a filtered flow channel.

In certain situations, it may be beneficial to use logarithmic or linear amplification methods (e.g., PCR, isothermal amplification, etc.) to increase the number of oligos (e.g., capture-associated oligos and/or complements thereof) available for binding to the electrode-associated oligos, thus enhancing the signal created through complementary binding. Such methods of amplification are well known in the art and may include polymerase chain reaction (“PCR”) and linear amplification via such polymerases as T7 polymerase. In such embodiments, a capture-associated oligo must be designed to incorporate a polymerase (e.g., 5′ to 3′ RNA or DNA polymerase) recognition sequence to allow binding of a polymerase enzyme that can amplify at least the portion of the capture-associated oligo that corresponds to (e.g., is complementary or identical to) the electrode-associated oligo (e.g., to produce an RNA or DNA amplification product, respectively). If the polymerase binding sequence is in single-stranded form, it is hybridized to its nucleic acid complement to create a double-stranded polymerase binding site prior to addition of an appropriate polymerase, many of which are well known to those of ordinary skill in the art. Alternatively, the capture-associated oligo can be engineered to contain a double-stranded portion comprising the polymerase recognition site, thereby eliminating the step of hybridization of an oligonucleotide to create such a double-stranded site.

As noted above, the capture-associated oligo may be conjugated to the capture moiety at either the 3′ or 5′ end. If the capture-associated oligo is conjugated to the capture moiety at the 3′ end, then the polymerase recognition site is preferably located between the capture moiety and the region corresponding to (e.g., identical or complementary to) a sequence of the electrode-associated oligo. If the capture-associated oligo is conjugated to the capture moiety at the 5′ end, then the polymerase recognition site is preferably located at the end of the capture-associated oligo that is distal to the capture moiety. In certain embodiments, a termination signal is also engineered into the capture-associated oligo at the nucleotide position at which the polymerase is to terminate polymerization, e.g., a position after the region of the capture-associated oligo that is complementary or identical to an electrode-associated oligo.

In some embodiments, the capture-associated oligo is used as a template for linear amplification, and the capture-associated oligo is therefore designed to encode a) a sequence identical to a sequence of the corresponding electrode-associated oligo (as opposed to a sequence complementary to a sequence of the electrode-associated oligo, as would be the case if the capture-associated oligo were to be hybridized directly to the electrode-associated oligo), and b) a sequence corresponding to a polymerase recognition sequence at its 3′ end adjacent to or overlapping with the region identical to a sequence of the electrode-associated oligo. Following binding of the target agent to the capture moiety and isolation of the resulting “reacted capture-associated oligo complex” from the sample (using, for example, immobilized binding partners as discussed herein), an oligonucleotide encoding the complement to the polymerase recognition sequence encoded by the capture-associated oligo is introduced to the reacted capture-associated oligo complex, and its binding to the complex creates a double-stranded polymerase recognition site. (Alternatively, as noted above, the capture-associated oligo could be engineered to contain a double-stranded portion comprising the polymerase recognition site, thereby eliminating the step of hybridization of an oligonucleotide to create such a double-stranded site.) The reacted capture-associated oligo comprising a double-stranded polymerase recognition site (whether by design or hybridization) is exposed to an aqueous solution comprising a polymerase and an excess of NTP or dNTP under conditions that allow the polymerase and reactants to create an intermediate duplex comprising a double-stranded DNA (or RNA-DNA hybrid, depending on, e.g., the polymerase and nucleotides used) having a first end that bears a polymerase recognition site (e.g., a phage-encoded RNA recognition site). As this reaction continues, the polymerase displaces the nascent strand of the double-stranded nucleic acid, resulting in multiple oligos that are complementary to the capture-associated oligo and the electrode-associated oligo on the electrochemical detection device. As noted above, in such an embodiment, the electrode-associated oligo will have the same sequence as the capture-associated oligo, and both will be complementary to the linear amplification products. In certain embodiments, the amplification methods disclosed herein can be combined with methods to separate reacted capture-associated oligos from unreacted capture-associated oligos. Specific examples of electrochemical detection methods utilizing nucleases, polymerases, or a combination thereof are provided, e.g., in U.S. Ser. No. 11/703,103, filed Feb. 7, 2007, entitled “Device and Methods for Detecting and Quantifying One or More Target Agents,” incorporated by reference herein.

### Specific Embodiments

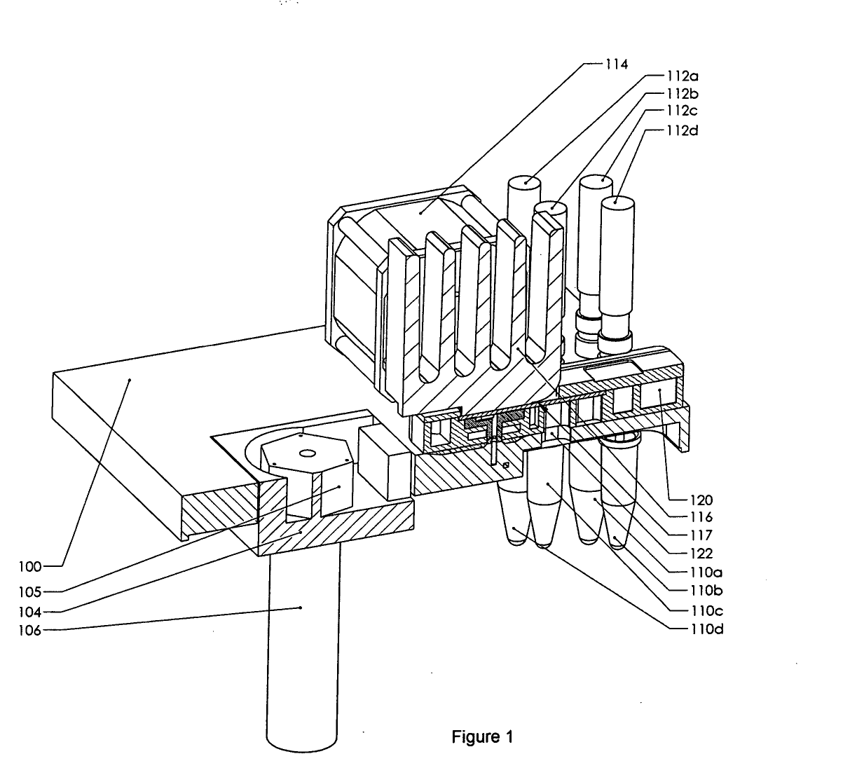

One embodiment of an electrochemical detection device of the present invention is seen in FIG. 1. This embodiment of the device comprises a chassis (100), which, in a preferred embodiment is a fluidics monoblock having fluidics paths therethrough; a pump housing (104), a pump rotor (105) and a pump motor (106) for a peristaltic pump; reagent reservoirs (110 a-d) in a block configuration; valves (112 a-d) (in one embodiment, solenoid valves); a fan (114) for which to cool a heat sink (116), where heat sink (116) has a bottom surface (117) with a heater disposed or otherwise mounted thereon (not shown); an electrochemical detection chip (120) seen here in cross section; a pass through (122) for an electrical connection to the electrochemical detection chip; and a waste path (140).

FIG. 2A provides an exploded view of an electrochemical device of the present invention showing the chassis as a fluidics monoblock (102), with a pump rotor (105) disposed therein and an air intake port (124) disposed therethrough. The fluidics monoblock (102) further comprises valve mounts (130 a-d), in fluid connection with reagent draw tubes (128 a-d), three of which are configured as inlets to draw reagent from reagent reservoirs (for example, 110 b-d) while one reagent draw tube is configured to be an outlet tube for one of the reagent reservoirs (for example, 110 a). Valves (112 a-d) are shown exploded away from fluidics monoblock (102), but in operation would seat into valve mounts (130 a-d). Three of valves (112) control the flow of liquids, where one valve controls the flow of air, where the air separates the liquids in a fluidics path. The flow of air is also useful for drying out the system after washing and/or between uses. Fan (114) is seen exploded away from fluidics monoblock (102), as is heat sink (116). A electrochemical detection chip (120) is seen exploded away from the fluidics monoblock (102) above where it would be seated if in operational position. Electrochemical detection chip (120) will interface with the device electrically at pass through (122) and fluidic interface ports (126 a and b), where one fluidic interface port is a fluidic inlet and one fluidic interface port is a fluidic outlet. Also seen in FIG. 2A is control board (132), processing board (134), and the bottom surface (117) of heat sink (116) on which is disposed a heater.

FIG. 2B is a pictorial view of the embodiment of the device seen in FIG. 2A. Again, fluidics monoblock (102), reagent reservoirs (110 a-d), solenoid valves (112 a-d), fan (114), heat sink (116), electrochemical detection chip (120), air intake port (124), control board (132) and processing board (134) are seen.

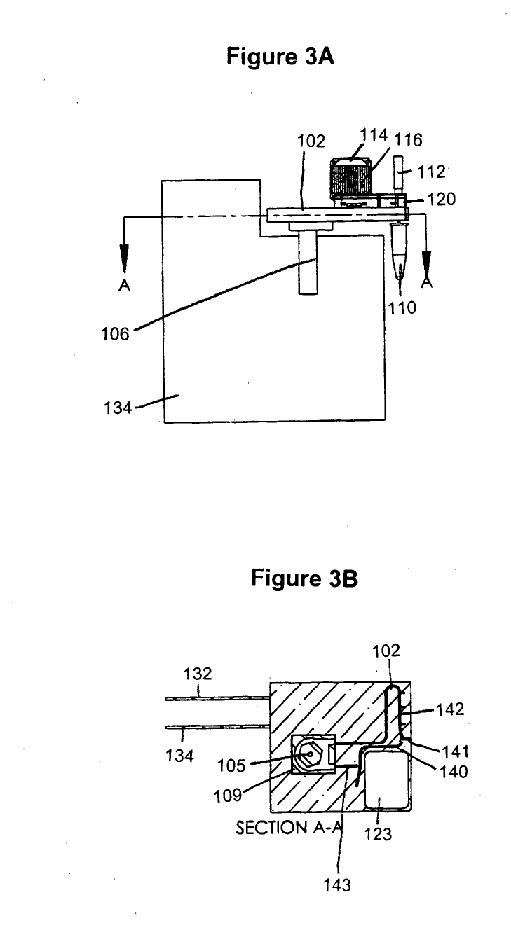

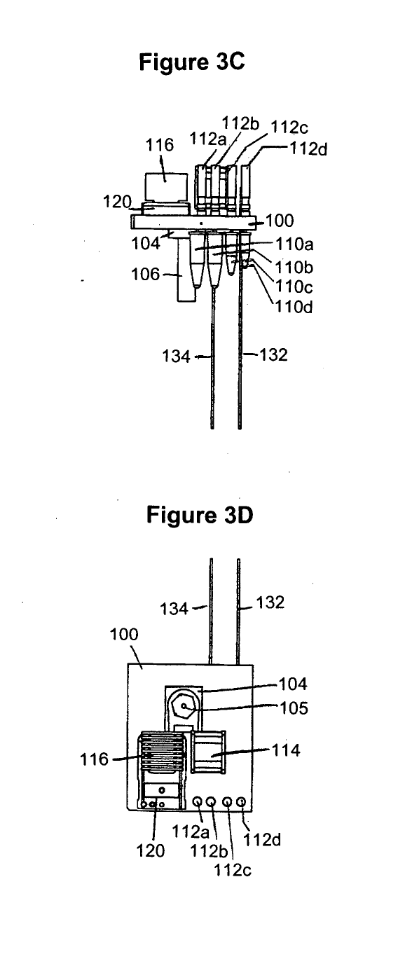

FIG. 3A is a side view of one embodiment of an electrochemical detection device of the present invention, showing fluidics monoblock (102), pump motor (106), valve (112), a reagent reservoir (110), fan (114), and heat sink (116). The electrochemical detection chip (120) is shown in position. Also seen in FIG. 3A is processing board (134).

FIG. 3B is a sectional view of taken through FIG. 3A at A-A. The fluidics monoblock (102) comprises aperture (109) to accommodate the pump housing (104, not shown) and pump rotor (105), a cavity (123) to accommodate an electrical board (not shown), where cavity (123) is contiguous with pass through (122, not shown) which allows the pass through of electrical connections to interface with the electrochemical detection chip (120, not shown). A control board (132) and a processing board (134) are seen as well. Also seen in FIG. 3B are fluid passages disposed within fluidics monoblock (102), including waste path (140) for removing waste fluids from the electrochemical detection chip, a reagent manifold (142) to deliver reagents to the pump, and high pressure line (143) to deliver reagents from the pump to the electrochemical detection chip (120). In addition, an air intake path (141) is disposed within fluidics monoblock (102).

FIG. 3C is a front view of an embodiment of an electrochemical detection device of the present invention, comprising a chassis (100), a pump housing (104), a pump motor (106), reagent reservoirs (110 a-d), solenoid valves (112 a-d), a heat sink (116), an electrochemical detection chip (120), a control board (132) and a processing board (134). FIG. 3D is a top view, comprising a chassis (100), a pump housing (104), a pump rotor (105), solenoid valves (112 a-d), a fan (114), a heat sink (116), an electrochemical detection chip (120), a control board (132) and a processing board (134).

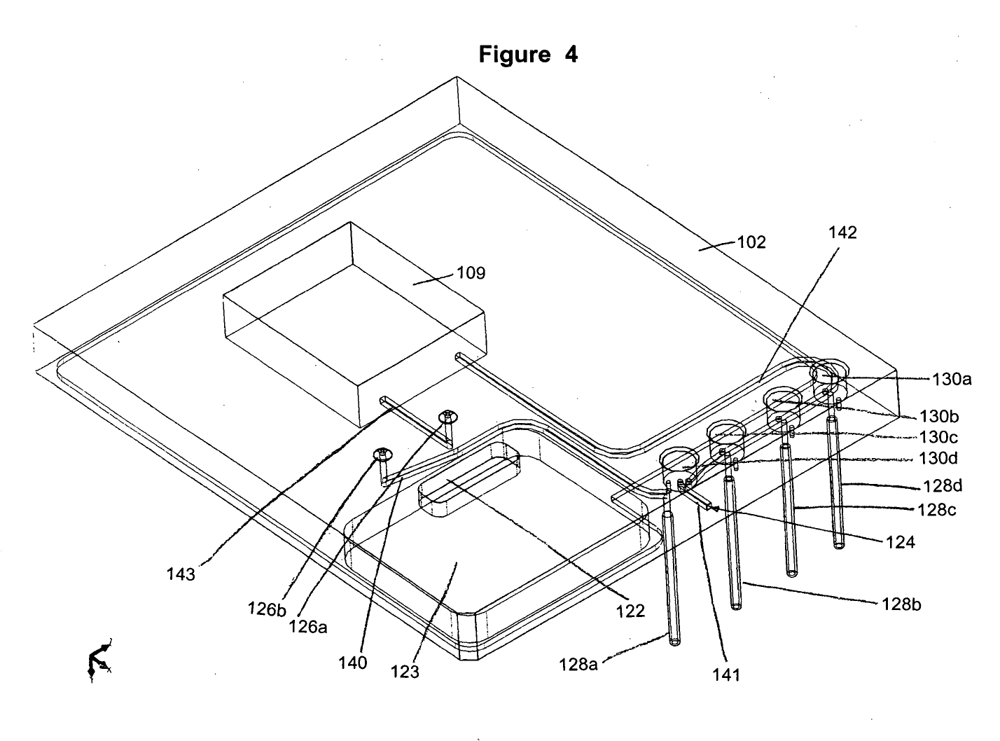

FIG. 4 is a wireform pictorial of one embodiment of a fluidics monoblock (102) useful in the present invention. Fluidics monoblock (102) comprises an aperture (109) to accommodate the pump, a pass through (122) for electrical interface with the electrochemical detection chip (not shown), a cavity (123) to accommodate the electrical board for electrical interface with the electrochemical detection chip (not shown), an air intake port (124), fluidic interface ports (126 a and b), reagent draw tubes (128 a-d), valve mounts (130 a-d), a waste path (140), an air intake path (141), reagent manifold (142) and a high pressure line (143).

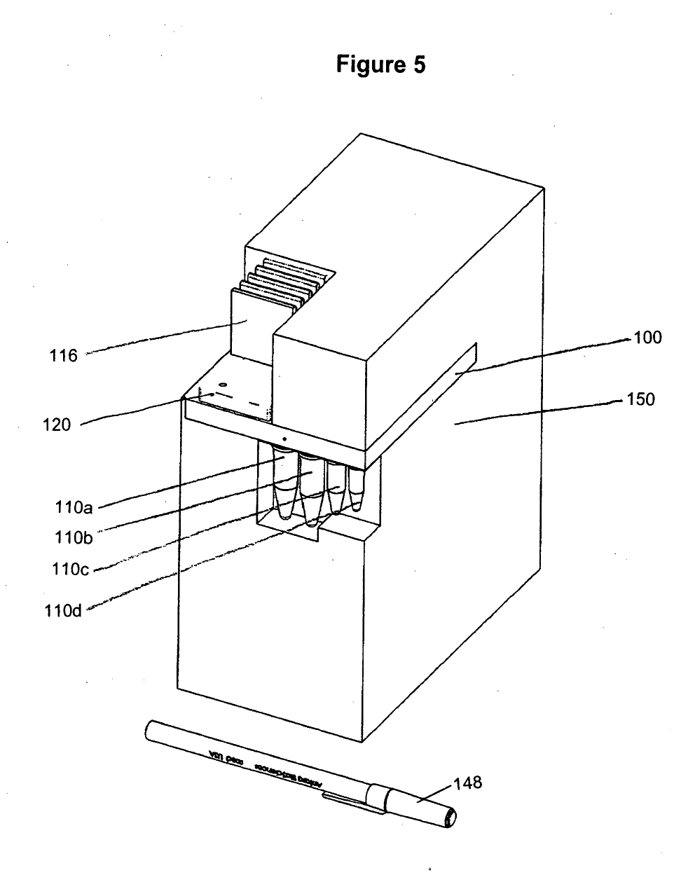

FIG. 5 is a covered view of FIG. 2B, showing an electrochemical detection device of the present invention having a cover (150). The size of the device depicted in FIG. 5 is given perspective by providing ball point pen (148) for scale. In this view, chassis (100, preferably a fluidics monoblock 102), reagent reservoirs (110 a-d), heat sink (116), and electrochemical detection chip (120) are visible.

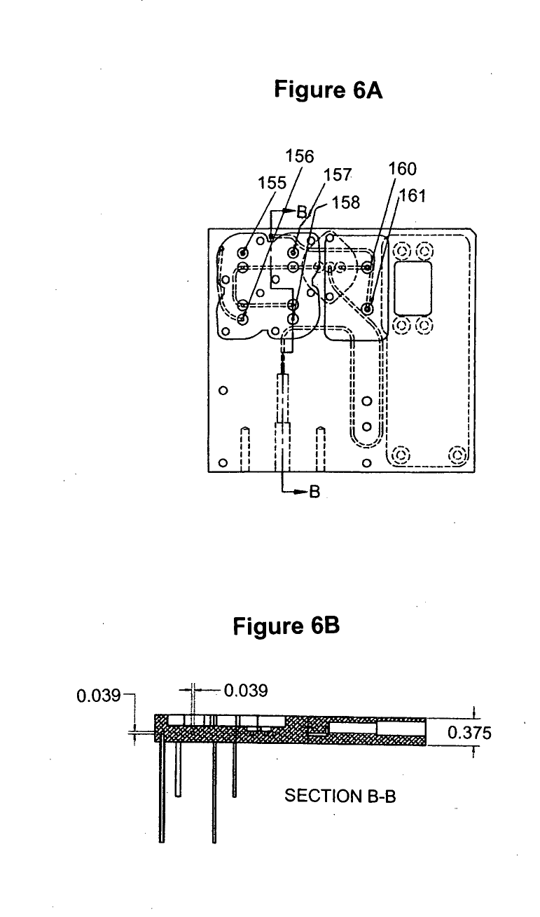

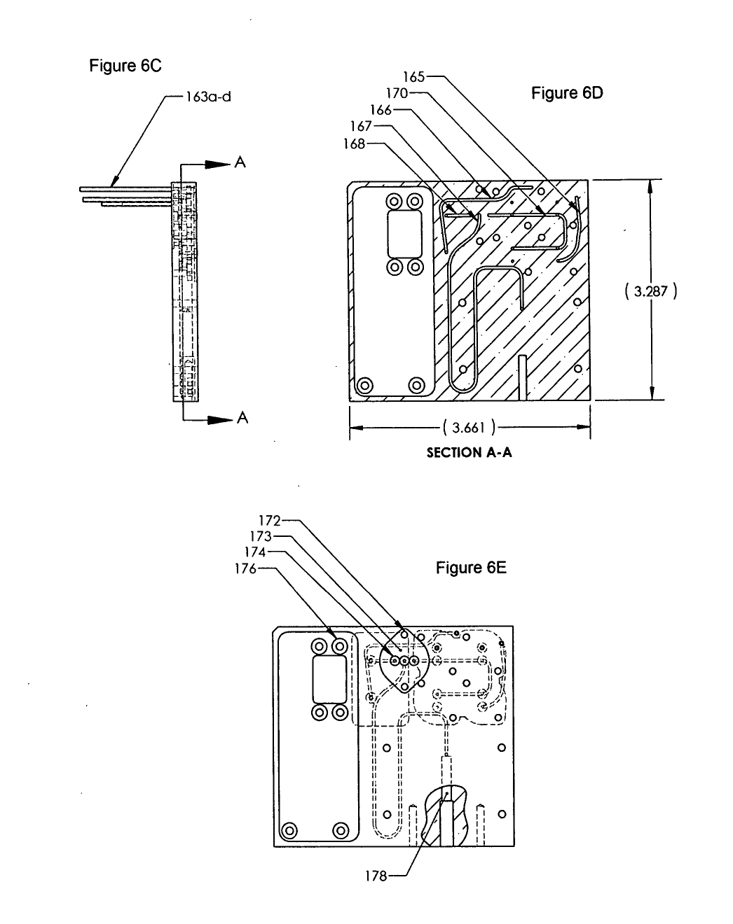

FIG. 6 shows several views of one embodiment of a fluidic monoblock component of the present invention. The manifold in this embodiment is machined, injection-molded, glued, and/or ultrasonically-welded to make fluid-tight channels and chambers without the need for internal tubing and fittings, and can be made of materials including but not limited to PVC, ABS, and acrylic (compatible and solvent bondable). The fluid paths are shown to be 1 mm×1 mm, but could be larger, smaller, and of a configuration other than round (e.g., half-domed). For example, in some embodiments the fluid paths have a diameter from 50 μm to 8 mm, or from ⅓ mm to 2 mm. In the present embodiment, as in preferred embodiments, the fluid path lengths are minimized to reduce reagent consumption, waste, wash volumes and hazardous waste volume. Also shown are two screw holes for mounting a syringe, which may be a “dry syringe” in which the syringe seal is kept separate from process chemistry. Also in this embodiment, the reagent draw tubes are clustered to allow for a one-piece molded single-use reagent pack including a waste vial. In particular, FIG. 6A illustrates a buffer inlet (155), a water inlet (156), a dye inlet (157), an air inlet (158), a cartridge inlet port (160), and a cartridge outlet port (161). FIG. 6B shows section B-B of FIG. 6A, and includes certain dimensions (in inches). FIG. 6C provides a side view including reagent draw tubes (163a-d), one of which may be a waste tube. FIG. 6D shows section A-A of FIG. 6C, includes certain dimensions (in inches), and illustrates various components including water line (165), waste line (166), pump storage line (167), cartridge inlet line (168), and reagent manifold (170). FIG. 6E depicts various components including valve mounting holes (of which there are 10, e.g., 172), syringe control valve mount (173), valve interface preparations (of which there are 1, e.g., 174), electronic interface board mount features (of which there are 6, e.g., 176), and syringe body (178). In certain preferred embodiments, the fluid paths are hydrophobic in order to reduce volume loss on the sides of the channels.

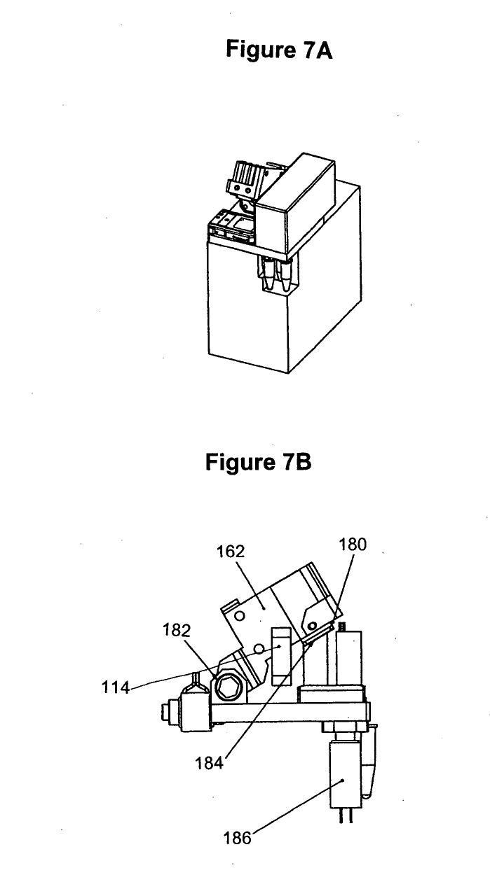

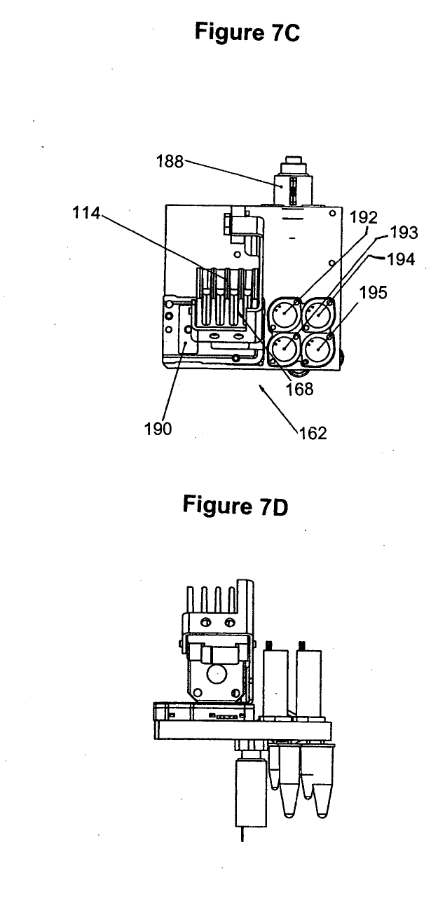

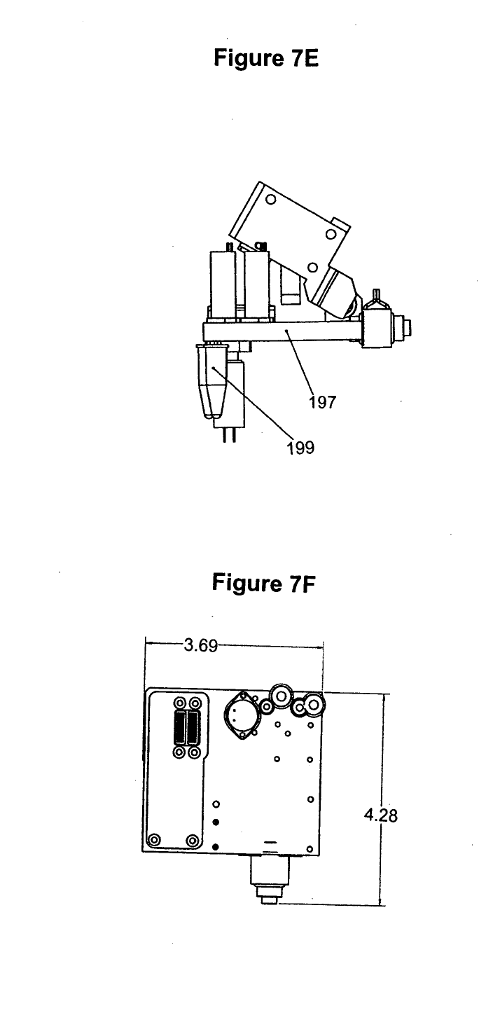

FIG. 7 shows several views of one embodiment of a system assembly diagram. In particular, FIG. 7A shows an outside view of the system assembly with covers, and FIG. 7B depicts various components including a heat sink mount user interface (180), a heat sink mount (shown in upright position; 162), a spherical bearing (182), a fan (114), a heat sink with heater attached to a face indicated by the arrowhead (184), and a syringe control valve (186). FIG. 7C illustrates a top view showing various components including a syringe pump motor (188), a fan (114), a removable cartridge (190), a heat sink (168), a heat sink mount (162), an air valve (192), a dye valve (193), a water valve (194), and a buffer valve (195). FIGS. 7D and 7E show side views, with FIG. 7E further indicating the fluidic block (197) and the reagent reservoirs (199). FIG. 7F provides a bottom view including certain dimensions (in inches).

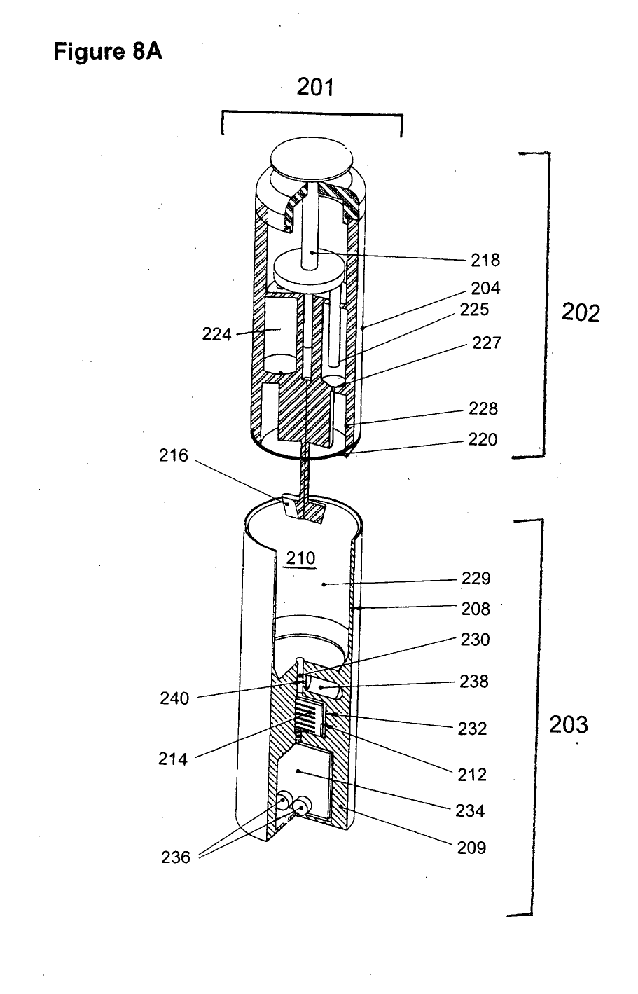

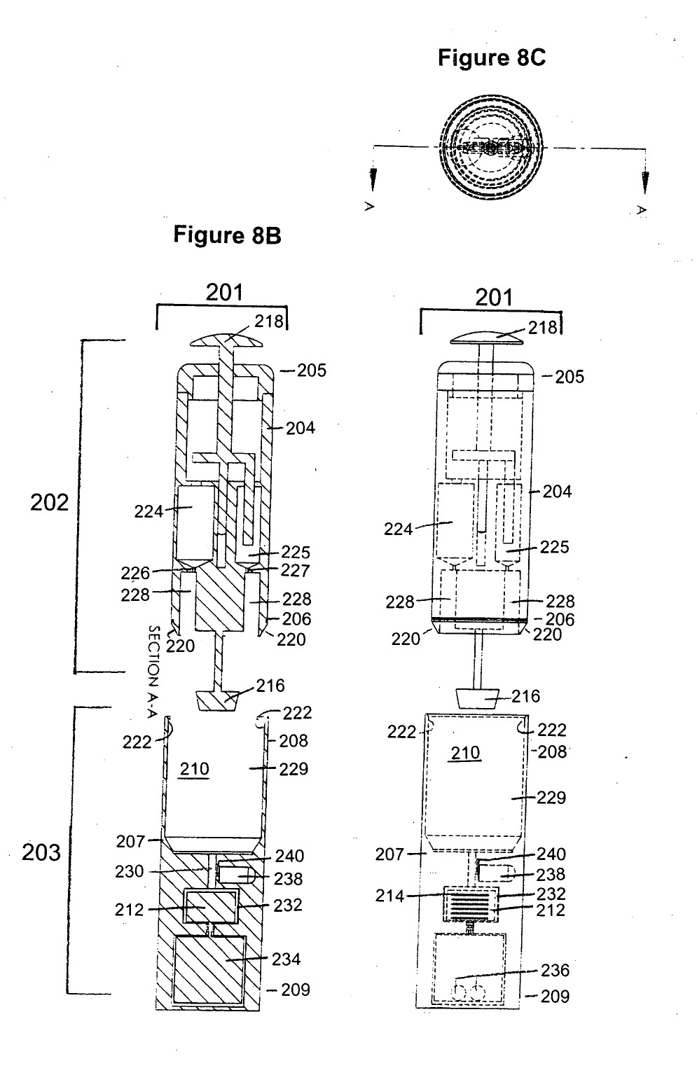

One embodiment of the device of the present invention is seen in three differing views in FIGS. 8 A-C. This embodiment comprises a detection device (201) having two modules: a chemistry module (202) and an electronics module (203). The chemistry module comprises a housing (204) having a plunger end (205) and a seal end (206). The plunger end (205) of the housing (204) of the chemistry module (202) is capable of receiving one or more plungers (218). Here one plunger (218) is shown. One plunger may be used instead of multiple plungers so long as the single plunger is configured so as to initiate the delivery of reagents from each of the reagent chambers (224 and 225), for example, by utilizing a rotatable plunger (218). Chemistry module (202) also comprises a sample collection element (216) that protrudes from the seal end (206) of housing (204) and may be integral with the housing (204). Although a sample collection element (216) is shown in FIG. 8, the present invention envisions embodiments where there would be no sample collection element. Instead, a sample could be introduced directly into reaction chamber (210), or the sample collection element could be disposed within chamber end (208) of the electronics module (203). The chemistry module (202) further comprises at least two reagent chambers (224 and 225), fluidly connected to the chemistry module portion (229) of the reaction chamber (210) through reagent ports (226 and 227). The seal end (206) of housing (204) of the chemistry module (202) has an o-ring-like seal (220) that engages and forms a liquid-tight seal with the seal engaging surface (222) of housing (207) of the electronics module (203). (In the embodiments described herein, seal (220) is typically described as an o-ring seal. Alternative embodiments include chemistry module (202) and electronics module (203) threaded so as to screw together, or other configurations known to those in the art.) The electronics module (203) further comprises a chamber end (208) forming a portion (229) of reaction chamber (210). The chamber end (208), of the electronics module (202) further comprises a filtered flow channel (230) in fluid connection with portion (229) of reaction chamber (210) and with an electrochemical reagent chamber (238) through an electrochemical reagent port (240). The electronics module (202) further comprises a sensor (212) disposed in a sensor chamber (232) where sensor (212) has a plurality of sensor electrodes (214), electronics and power elements (234) as well as indicator lights (236).

Use of the embodiment of the present invention shown in FIG. 8 comprises: (a) a sensor (212) comprising an electrode-associated oligo immobilized on a plurality of electrodes (214); (b) a first reagent comprising a capture-associated oligo that is complementary to the electrode-associated oligo, where the capture-associated oligo is conjugated to a capture moiety specific for the target agent to be detected and is contained within reagent chamber (224); (c) a second reagent comprising immobilized binding partners that specifically bind to the capture moiety contained within the reagent chamber (225); and (d) a sample suspected of containing the target agent on sample collection element (216). Once there is a sample on a sample collection element (216) of device (201), the chemistry module (202) is coupled to the electronics module (203), forming a liquid-tight environment through the engagement of seal (220) of housing (204) with the seal engaging surface (222) of housing (207). The coupling of the chemistry module (202) to the electronics module (203) forms a reaction chamber (210) having a portion (228) formed by housing (204) and a portion (229) formed by housing (205). The first reagent stored in reagent chamber (224) is delivered to the reaction chamber (210) through reagent port (226). Once the first reagent is delivered to the reaction chamber (210), the capture moiety of the capture-associated oligo complex is allowed to bind the target agent of the sample.

The second reagent containing immobilized binding partners that specifically bind to the capture moiety stored in reagent chamber (225) is delivered to the reaction chamber (210) through reagent port (227). Unreacted capture moieties (i.e., not bound to target agent) from the first reagent react with the immobilized binding partners, thereby forming a solution phase and an immobilized phase whereby unreacted capture moieties are removed from the solution phase. The resultant solution phase is then filtered through the filtered flow channel (230) into the sensor chamber (232). As the solution passes through the filtered flow channel, an electrochemical indicator stored in electrochemical reagent chamber (238) is added to the solution. Once the solution reaches sensor chamber (232), the solution contacts the sensor (212) and the sensor electrodes (214) having the electrode-associated oligos thereon. If a hybridization event occurs between the electrode-associated oligos and the capture-associated oligos, target agent was present in the sample. The hybridization event is detected by electrochemical detection using electronics and battery (234). Indicator lights (236) notify the user of the result of the test.

In addition, in certain embodiments described herein, it has been described that the first reagent and the second reagent are liquids; however, it is also envisioned that in an alternative embodiment, one or more of the first or second reagent or enzyme or electrochemical reagent is freeze-dried or otherwise converted to solid form, such that delivery of water, buffer or other solution into the reagent chambers (224 and 225) or enzyme chamber (244) or electrochemical reagent chamber (238) solubilizes the solid for subsequent delivery. In another alternative, the first reagent resides in solid form in the reaction chamber (210), and either the sample is added in a buffer or appropriate solution for the first reaction to take place, or a buffer or other solution is delivered to the reaction chamber (210) once the chemistry module (202) has been coupled to the electronics module (203).

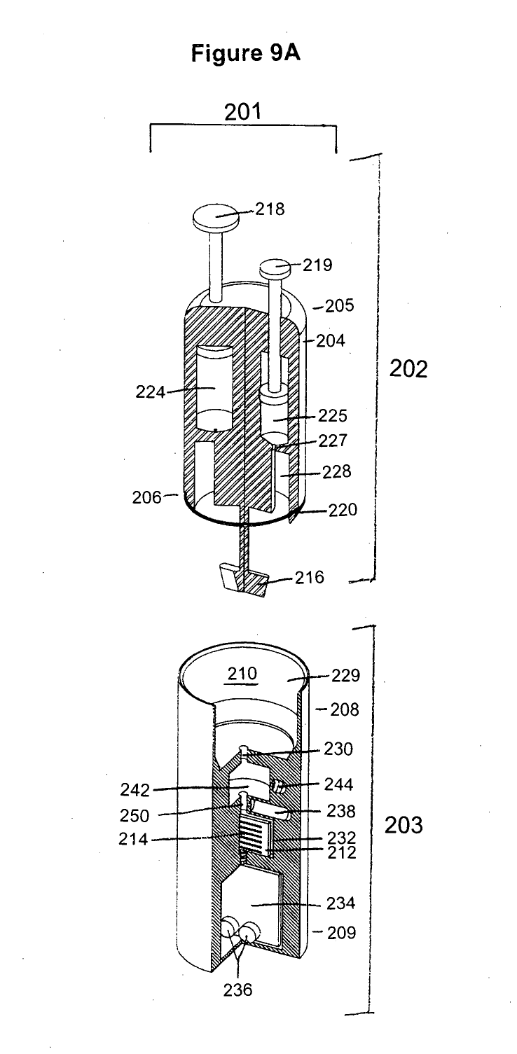

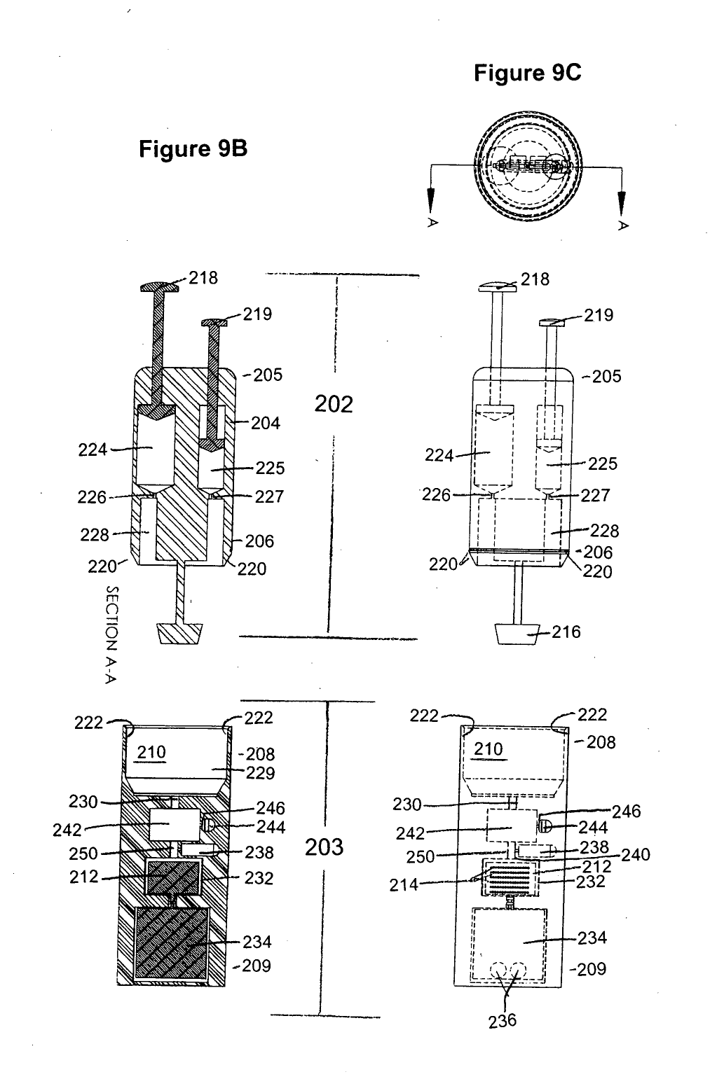

An alternative embodiment of the device of the present invention is seen in three differing views in FIGS. 9 A-C. This embodiment comprises a detection device (201) having two modules: a chemistry module (202) and an electronics module (203). The chemistry module comprises a housing (204) having a plunger end (205) and a seal end (206). The plunger end (205) of the housing (204) of the chemistry module (202) is capable of receiving one or more plungers, in this embodiment, two plungers are shown (218 and 219). The plungers are depressed at the appropriate time so as to deliver reagents to the reaction chamber from the reagent chambers (224 and 225, respectively) through reagent ports (226 and 227, respectively). As seen here, the chemistry module (202) also may comprise a sample collection element (216) that protrudes from the seal end (206) of housing (204) and may be integral with the housing (204). However, some embodiments eliminate the sample collection element and instead a sample is delivered directly into reaction chamber (210). The chemistry module (202) further comprises at least two reagent chambers (224 and 225), fluidly connected to the chemistry module portion (229) of the reaction chamber (210) through reagent ports (226 and 227). The seal end (206) of housing (204) of the chemistry module (202) has an o-ring-like seal (220) that engages and forms a liquid-tight seal with the seal engaging surface (222) of housing (207) of the electronics module (203). The electronics module (203) further comprises a chamber end (208) forming a portion (229) of reaction chamber (210). The chamber end (208), of the electronics module (202) further comprises a filtered flow channel (230) in fluid connection with portion (229) of reaction chamber (210) and with a second reaction chamber (242). The second reaction chamber (242), in addition, is in fluid connection with an enzyme chamber (244) through an enzyme port (246). The second reaction chamber is in fluid connection with a sensor port (250), which is in fluid connection with an electrochemical reagent chamber (238) through an electrochemical reagent port (240). The electronics module (202) further comprises a sensor (212) disposed in a sensor chamber (232) where sensor (212) has a plurality of sensor electrodes (214), electronics and power elements (234) as well as indicator lights (236).

The embodiment of the present invention shown in FIG. 9 comprises: (a) a sensor (212) comprising an electrode-associated oligo immobilized on a plurality of electrodes (214); (b) a first reagent comprising a capture-associated oligo that is complementary to the electrode-associated oligo, where the capture-associated oligo is conjugated to a capture moiety specific for the target agent to be detected and is contained within reagent chamber (224) to be delivered through reagent port (225) initiated by plunger (218); (c) a second reagent comprising immobilized binding partners that specifically bind to the capture moiety is contained within reagent chamber (225) to be delivered through reagent port (226) initiated by plunger (219); and (d) a sample suspected of containing the target agent on sample collection element (216). Once there is a sample on a sample collection element (216) of device (201), the chemistry module (202) is coupled to the electronics module (203), forming a liquid-tight environment through the engagement of seal (220) of housing (204) with the seal engaging surface (222) of housing (207). The coupling of the chemistry module (202) to the electronics module (203) forms a reaction chamber (210) having a portion (228) formed by housing (204), and a portion (229) formed by housing (207).

The first reagent stored in reagent chamber (224) is delivered to the reaction chamber (210) through reagent port (226) initiated by plunger (218). Once the first reagent is delivered to the reaction chamber (210), the capture moiety of the capture-associated oligo complex is allowed to bind the target agent of the sample. The second reagent containing immobilized binding partners that specifically bind to the capture moiety stored in reagent chamber (225) is delivered to the reaction chamber (210) from a reagent through reagent port (227) initiated by plunger (219). Unreacted capture moieties (i.e., not bound to target agent) from the first reagent react with the immobilized binding partners, thereby forming a solution phase and an immobilized phase whereby unreacted capture moieties are removed from the solution phase. The resultant solution phase is then filtered through the filtered flow channel (230) into a second reaction chamber (242). While in the second reaction chamber, an enzyme residing in enzyme chamber (244) is delivered to the solution phase in second reaction chamber (242) through enzyme port (246). The enzyme used is one that catalyzes the cleavage of the capture-associated oligo from the capture moiety. Once the cleavage reaction is complete, the solution is transferred to the sensor chamber (232) through sensor port (250), which is in fluid connection with an electrochemical reagent chamber (238) through an electrochemical reagent port (240). As the solution passes through sensor channel (250), an electrochemical indicator stored in electrochemical reagent chamber (238) also may be added to the solution. Once the solution reaches sensor chamber (232), the solution contacts the sensor (212) and the sensor electrodes (214) having the immobilized electrode-associated oligos thereon. If a hybridization event occurs between the electrode-associated oligos and the capture-associated oligos, target agent was present in the sample. The hybridization event is detected by electrochemical detection using electronics and battery (234). The indicator lights (236) give the user the results of the test.

In yet another embodiment, it is envisioned that a third chamber (located, for example, aside or in between reagent chambers 224 and 225) acts as a waste receptacle, with a waste ports (aside or in between reagent ports 225 and 227, for example) being a filtered flow channel. A drawing means, such as a syringe, would be configured with the waste receptacle in order to allow fluid to be drawn from the reaction chamber into the waste receptacle. In such an embodiment, the first reagent stored in reagent chamber (224) is delivered to the reaction chamber (210) through reagent port (226) initiated by plunger (218). Once the first reagent is delivered to the reaction chamber (210), the capture moiety of the capture-associated oligo complex is allowed to bind the target agent of the sample. A second reagent, in this embodiment containing immobilized binding partners that specifically bind to the target agent or capture moiety/target agent combination is stored in reagent chamber (225) and delivered to the reaction chamber (210) from a reagent through reagent port (227) initiated by plunger (219). In this case, capture moieties that have reacted with the target agent react with the immobilized binding partners, thereby forming an immobilized phase and a solution phase whereby reacted capture moieties are immobilized and unreacted capture moieties are in the solution phase. The resultant solution phase is then drawn through the filtered waste port into a waste chamber, leaving the reacted capture moiety/targets immobilized. While in the reaction chamber, an enzyme and buffer residing in an enzyme chamber in fluid connection with the reaction chamber (which would be a third reagent chamber and may also be located, for example, aside or in between reagent chambers 224 and 225) is delivered to the immobilized phase through an enzyme port (246). As in previous embodiments, the enzyme used is one that catalyzes the cleavage of the capture-associated oligo from the capture moiety. Once the cleavage reaction is complete, the solution is passed through the sensor port (230) through filtered flow channel to the sensor chamber (232). The sensor chamber is also in fluid connection with an electrochemical reagent chamber (238) through an electrochemical reagent port (240). Once the solution reaches sensor chamber (232), the solution contacts the sensor (212) and the sensor electrodes (214) having the immobilized electrode-associated oligos thereon. If a hybridization event occurs between the electrode-associated oligos and the capture-associated oligos, target agent was present in the sample. The hybridization event is detected by electrochemical detection using electronics and battery (234). The indicator lights (236) give the user the results of the test.

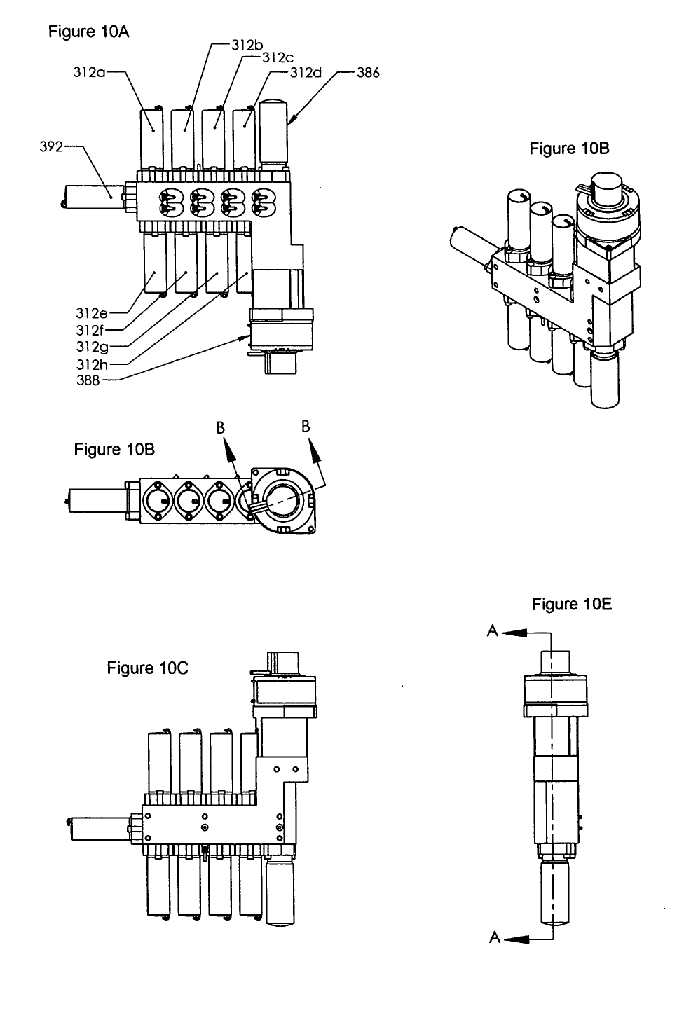

FIGS. 10-13 provide various views of a specific embodiment of a fluidics module of the present invention, herein termed “fluidics module A1.” In certain embodiments, fluidics module A1 can be a part of a compact electrochemical detection device that is approximately 4 inches wide, 7 inches high, and 7 inches deep. In a specific embodiment, the electrochemical device is 4.5 inches wide, 7.5 inches high, and 9.5 inches deep. FIG. 10 provides a hidden line view and includes elements such as an air valve (392), reagent valves (312a-h), a pump valve (386), and a pump motor (388). In preferred embodiments, the pump comprises a dry seal, as discussed above. FIGS. 10A-C show fluidics module A1 upside down, from the top looking down, and rightside up, respectively. FIG. 10E shows fluidics module A1 from the end proximal to the pump valve.

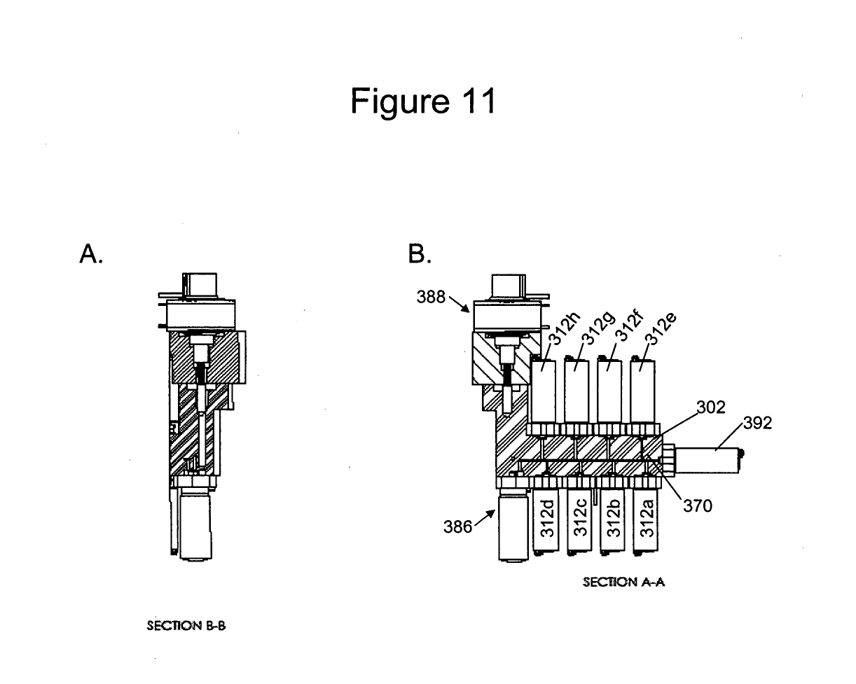

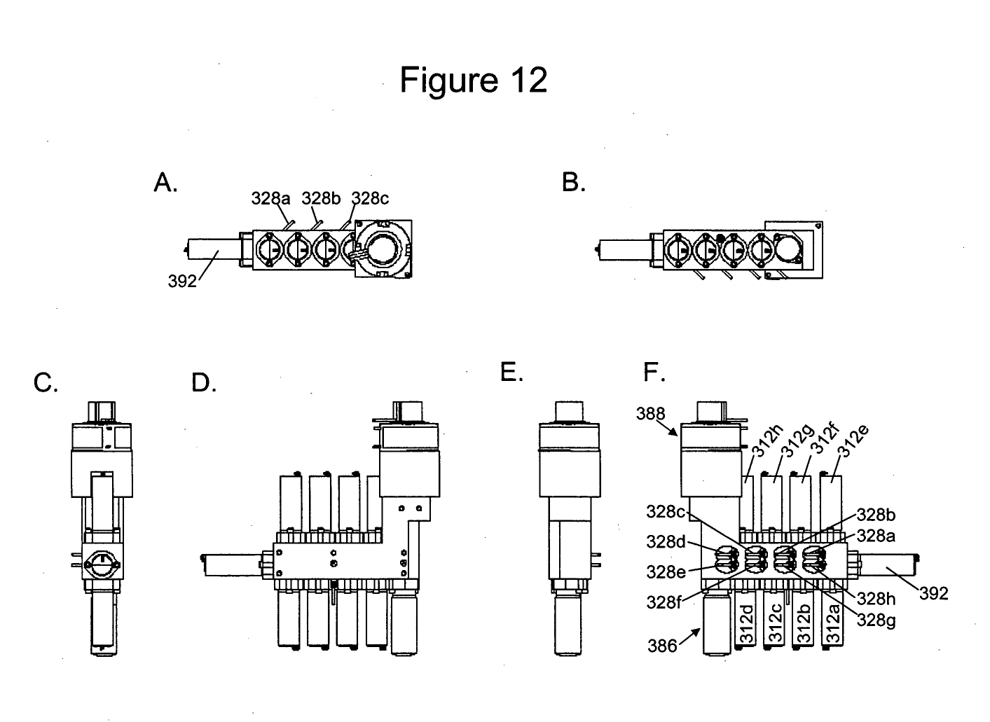

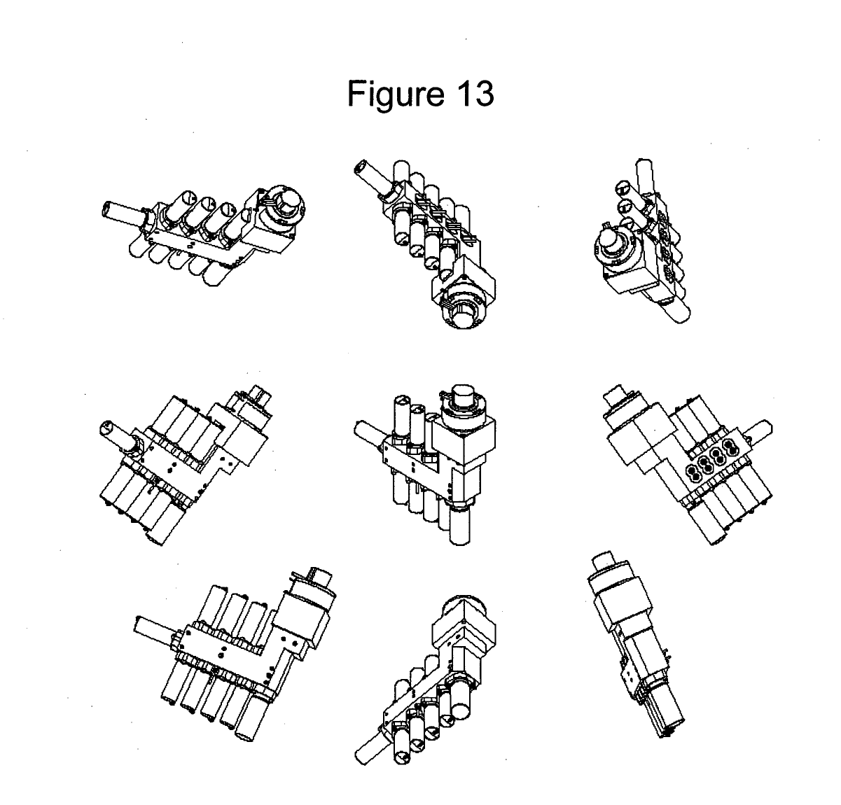

FIG. 1A illustrates cross-section B-B identified in FIG. 10B, and FIG. 11B illustrates cross-section A-A identified in FIG. 10E. Also shown in FIG. 11B is a fluidics monoblock (302), a reagent manifold (370), air valve (392), reagent valves (312a-h), a pump valve (386), and a pump motor (388). FIG. 12 provides orthogonal views of fluidics module A1, and includes air valve (392), reagent draw tubes (328a-h), reagent valves (312a-h), a pump valve (386), and a pump motor (388). Views in FIGS. 12A-F are of the top, bottom, back, right side, front, and left side, respectively. In specific embodiments, reagent draw tube 328h is an air draw tube and is attached to an air inlet. FIG. 13 provides isometric views of fluidics module A1, and although no particular components are labeled they can be assumed to be the same as in FIGS. 10-12.

The Electrochemical Detection Chip

A device of the present invention is used for electrochemical detection, in a preferred embodiment, a device of the present invention is used to detect a hybridization event between complementary nucleic acids. (See, for example, U.S. Ser. No. 60/801,950, filed May 19, 2006, entitled “Alternative Methods of Electrochemically Detecting One or More Target Agents,” U.S. Ser. No. 60/802,002, filed May 19, 2006, entitled “Alternative Methods of Electrochemically Detecting One or More Target Agents,” U.S. Ser. No. 60/801,703, filed May 19, 2006, entitled “Alternative Methods of Electrochemically Detecting One or More Target Agents,” U.S. Ser. No. 60/802,049, filed May 19, 2006, entitled “Methods of Electrochemically Detecting and Quantifying One or More Target Agents,” U.S. Ser. No. 60/802,039, filed May 19, 2006, entitled “Methods of Electrochemically Detecting One or More Amplified Target Agents,” and U.S. Ser. No. 11/703,103, filed Feb. 7, 2007, entitled “Device and Methods for Detecting and Quantifying One or More Target Agents,” all filed by Antara BioSciences Inc. and incorporated by reference herein in their entireties for all purposes.) The hybridization of nucleic acid molecules, which have been selected through direct or indirect interaction with a particular target agent of interest (such as a potentially infectious or disease-causing agent, a chemical or biological toxin, a pathogenic agent, a drug, a drug metabolite, another metabolite, an environmental contaminant, or the like), to a complementary nucleic acid molecule that is attached or otherwise associated, directly or indirectly, with an electrode in an electrochemical detection device is employed as a means of indicating the presence of the particular target agent. As used herein, an “electrochemical detection protocol” is a protocol by which an electrochemical detection chip is processed prior to and including the actual electrochemical detection of hybridization of nucleic acids within the chip.

In accordance with the present invention, a nucleic acid molecule is immobilized (directly or indirectly) onto an electrochemical surface of an electrochemical detection chip. Although a metal electrode (e.g., gold, silver, silver chloride, aluminum, platinum, palladium, rhodium, ruthenium, any metal or other material having a free electron in its outer most orbital) is preferably employed as the surface for immobilizing the nucleic acid molecule, other surfaces such as photodiodes, thermistors, ISFETs, MOSFETs, piezo elements, surface acoustic wave elements, and quartz oscillators may also be employed. By “electrode” herein is meant a composition, which, when connected to an electronic device, is able to conduct, transmit, receive or otherwise sense a current or charge. This current or charge is subsequently converted into a detectable signal which is detected by an electrochemical detection device. Alternatively an electrode can be defined as a composition, which can apply a potential to and/or pass electrons to or from a chemical moiety. Preferred electrodes are known in the art and include, but are not limited to, certain metals and their oxides, including gold; silver; silver chloride; platinum; palladium; silicon; aluminum; titanium, metal oxide electrodes including platinum oxide, titanium oxide, tin oxide, indium tin oxide, palladium oxide, silicon oxide, aluminum oxide, molybdenum oxide (Mo₂,O₆), tungsten oxide (WO₃), and ruthenium oxides; carbon (including glassy carbon electrodes, graphite, pyrolytic graphite, carbon fiber, and carbon paste); and semiconductor electrodes, such as Si, Ge, ZnO, CdS, TiO₂, and GaAs. Preferred electrodes include gold, silver, silver chloride, silicon, platinum, carbon and metal oxide electrodes, with gold being particularly preferred. The electrode may also be covered with conductive compounds to enhance the stability of the electrodes immobilized with probes or nonconductive (e.g., insulative materials). Monomolecular films or biocompatible materials may also be employed to coat or partially coat the electrodes.

The electrodes described herein are presumed to be a flat surface, which is only one of the possible conformations of the electrode. The conformation of the electrode depends upon the detection method employed. For example, flat planar electrodes may be preferred for electrochemical detection methods, or when nucleic acid arrays are employed, thus requiring addressable locations for synthesis and/or detection. Alternatively, electrodes could be curved, for example, rolled up around a cylinder or in a spiral configuration to increase surface area while minimizing the volume required. In a preferred embodiment, the detection electrodes are formed on a glass or polymer substrate. In addition, the discussion herein is generally directed to the formation of gold electrodes, but as will be appreciated by those in the art, other electrodes can be used as well. The substrate can comprise a wide variety of materials, as will be appreciated by those in the art, with glass, polymers and printed circuit board (PCB) materials being particularly preferred. Thus, in general, the suitable substrates include, but are not limited to, fiberglass, Teflon, ceramics, glass, silicon, mica, plastic (including acrylics, polystyrene and copolymers of styrene and other materials, polypropylene, polyethylene, polybutylene, polycarbonate, polyurethanes, Teflon™, and derivatives thereof, etc.), GETEK (a blend of polypropylene oxide and fiberglass), and other materials typically employed and readily known to those of ordinary skill in the art.

As is generally known in the art, one or a plurality of layers may be used, to make either “two-dimensional” (e.g., all electrodes and interconnections in a plane) or “three dimensional” substrates. Three-dimensional systems frequently rely on the use of drilling or etching, followed by electroplating with a metal such as copper, such that the “through board” interconnections are made, or comprise porous structures similar to xeolites in structure. In addition, micron-sized “whiskers” may be used to increase electrode surface area.

Electrochemical detection chips (also referred to as “biochips” or “chips”) useful with an electrochemical detection device typically comprise a passive circuit chip disposed within a cartridge or detection chamber. Generally, the detection chamber volume ranges from about 1 pl to 1 ml, with about 10 μl to 500 μl being preferred. As will be appreciated by those in the art, depending on the experimental conditions and assay, smaller or larger volumes may be used. The volumes and concentrations employed are typically empirically determined using methods readily known to those of ordinary skill in the art. Such electrochemical detection chips can contain substrates comprising a plurality of electrodes, as described above. Each electrode typically has an interconnection that is attached to the electrode at one end and is ultimately attached to a device that can control the electrode and/or receive the signal transmitted via conductive means in contact with the electrode. That is, each electrode is independently addressable. The substrates can be part of a larger device comprising a detection chamber that exposes a given volume of sample to the detection electrode. Generally, the detection chamber ranges from about 1 pl to 1 ml, with about 10 μl to 500 μl being preferred. As will be appreciated by those in the art, depending on the experimental conditions and assay, smaller or larger volumes may be used. The volumes and concentrations employed are typically empirically determined using methods readily known to those of ordinary skill in the art.

In certain embodiments, a detection chamber and electrode are part of a cartridge that can be placed into an electrochemical detection device of the present invention comprising electronic components selected from the group comprising potentiometers, AC/DC voltage source, ammeters, processors, displays, temperature controllers, light sources, and the like. In a typical embodiment, the interconnections from each electrode are positioned such that upon insertion of the cartridge into the device, connections between the electrodes and the electronic components are established.

In certain embodiments, an electrode is coated with a biocompatible substance (such as dextran, carboxylmethyldextran, other hydrogels, polypeptides, polynucleotides, biocompatible and/or bio-inert matrices or the like), and one or more nucleic acid molecules are immobilized to such biocompatible substance. Such immobilization can be performed before, after or during the hybridization reaction.

Nucleic acid molecules, or oligos, may be immobilized onto the surfaces, such as electrodes, directly or indirectly, by covalent bonding, ionic bonding and physical adsorption. Examples of immobilization by covalent bonding include a method in which the surface of the electrode is activated and then the nucleic acid molecule is immobilized directly or indirectly through a cross-linking agent. Yet another method using covalent bonding to immobilize the nucleic acid molecule includes introducing an active functional group into the nucleic acid molecule followed by direct or indirect immobilization. The activation of the surface may be conducted by electrolytic oxidation in the presence of an oxidizing agent, or by air oxidation or reagent oxidation, as well as by covering with a film. Useful cross-linking agents include, but are not limited to, silane couplers such as cyanogen bromide and gamma-aminopropyl triethoxy silane, carbodiimide and thionyl chloride and the like. Useful functional groups to be introduced to the nucleic acid molecule may be, but are not limited to, sulfide, disulfide, amino, amide, amido, a carboxyl, a hydroxyl, carbonyl, oxide, phosphate, sulfate, aldehyde, keto, ester and mercapto groups. Other highly reactive functional groups may also be employed using methods readily known to those of ordinary skill in the art.

To detect multiple target agents in a sample simultaneously, multiple electrodes, or an electrode with multiple nucleic acid molecules attached in a predetermined configuration can be employed. For example, nucleic acid detection sensors, which use an electrochemical technique, can comprise a nucleic acid array or other structural arrangement to detect multiple target agents. For example, in such a configuration, a plurality of electrodes each having a distinct nucleic acid molecule affixed thereto or otherwise associated therewith can be arranged in predetermined configuration. In certain embodiments, the voltage applied to each electrode is equal. Additionally, to verify the hybridization to a particular nucleic acid molecule, the device comprising the electrodes preferably includes a switch circuit, a decoder circuit, and/or, a timing circuit to apply the voltage to the individual electrodes and to receive the output signal from each of the electrodes.

Electrochemical detection of a hybridization reaction can be enhanced by the use of a “detection moiety,” which is any one or a plurality of chemical moieties capable of enabling the molecular recognition on a biosensor (e.g., an electrochemical hybridization detector). In certain embodiments, the detection moiety can be any chemical moiety that is stable under assay conditions and can undergo reduction and/or oxidation. Examples of such detection moieties include, but are not limited to, purely organic labels, such as viologen, anthraquinone, ethidium bromide, daunomycin, methylene blue, and their derivatives, organo-metallic labels, such as ferrocene, ruthenium, bis-pyridine, tris-pyridine, bis-imidizole, and their derivatives, and biological labels, such as cytochrome c, plastocyanin, and cytochrome c′. Specific electroactive agents for use in the invention include a large number of ferrocene (Brazill, S. A., Kim, P. H. & Kuhr, W. G., Anal. Chem. 73, 4882-4890 (2001)) and viologen derivatives (Fan, C., Hirasa, T., Plaxco, K. W. and Heeger, A. J. (2003)) and any other stable agent capable of oxidation-reduction reactions. In specific embodiments, the detection moiety is comprised of a plurality of electrochemical hybridization detectors (e.g., ferrocene), optionally linked to a hydrocarbon molecule. Such molecules include but are not limited to ferrocene-hydrocarbon mixtures; such as ferrocene-methane, ferrocene-acetylene, and ferrocene-butane. In certain embodiments, a detection moiety is Fe(CN)63-/4-. In yet other embodiments, a detection moiety is a fluorescent label moiety. The fluorescent label may be selected from any of a number of different moieties. The preferred moiety is a fluorescent group for which detection is quite sensitive. Various different fluorescence labels techniques are described, for example, in Cambara et al. (1988) “Optimization of Parameters in a DNA Sequenator Using Fluorescence Detection,” Bio/Technol. 6:816 821; Smith et al. (1985) Nucl. Acids Res. 13:2399 2412; and Smith et al. (1986) Nature 321:674 679, each of which is hereby incorporated herein by reference. Fluorescent labels exhibiting particularly high coefficients of destruction may also be useful in destroying nonspecific background signals. In yet other embodiments, a detection moiety is a detection antibody reagent, where an antibody is labeled with a molecular entity which allows detection of nucleic acid binding. Examples of such reagents include, but are not limited to, antibody reagents that preferentially bind to RNA: DNA complexes.

In certain specific embodiments, a detection moiety is an electrochemical hybridization detector, for example, an intercalating agent characterized by a tendency to intercalate specifically to double-stranded nucleic acid such as double-stranded DNA. Typically, intercalating agents have in their molecules a flat intercalating group such as a phenyl group, which intercalates between the base pairs of the double-stranded nucleic acid, therefore binding to the double-stranded nucleic acid. Most intercalating agents comprise conjugated electron structures and are therefore optically active; some are commonly used in the quantification or visualization of nucleic acids. Certain intercalating agents exhibit an electrode response, thereby generating or enhancing an electrochemical response. As such, determination of physical change, especially electrochemical change, may serve to detect the intercalating agents bound to a double-stranded nucleic acid and so enhance the detection of a hybridization reaction.

Electrochemically active intercalating agents useful in the present invention include, but are not limited to, ethidium, ethidium bromide, acridine, aminoacridine, acridine orange, proflavin, ellipticine, actinomycin D, daunomycin, mitomycin C, Hoechst 33342, Hoechst 33258, aclarubicin, DAPI, adriamycin, pirarubicin, actinomycin, tris (phenanthroline) zinc salt, tris (phenanthroline) ruthenium salt, tris (phenantroline) cobalt salt, di (phenanthroline) zinc salt, di (phenanthroline) ruthenium salt, di (phenanthroline) cobalt salt, bipyridine platinum salt, terpyridine platinum salt, phenanthroline platinum salt, tris (bipyridyl) zinc salt, tris (bipyridyl) ruthenium salt, tris (bipyridyl) cobalt salt, di (bipyridyl) zinc salt, di (bipyridyl) ruthenium salt, di (bipyridyl) cobalt salt, and the like. Other intercalating agents that are useful are those listed in Published Japanese Patent Application No. 62-282599. Some of these intercalators contain metal ions and can be considered transition metal complexes. Although the transition metal complexes are not limited to those listed above, complexes which comprise transition metals having oxidation-reduction potentials not lower than or covered by that of nucleic acids are less preferable. The concentration of the intercalator depends on the type of intercalator to be used, but it is typically within the range of 1 ng/ml to 1 mg/ml. Some of these intercalators, specifically Hoechst 33258, has been shown to be a minor-groove binder and specifically binds to double-stranded DNA. The use of such electrochemically active minor groove binders is useful for detection of hybridization in electrochemical detection methods. Thus, in accordance with the present invention, the term “intercalator” is not intended to be limited to those compounds that “intercalate” into the rungs of the DNA ladder structure, but is also intended to include any moiety capable of binding to or with nucleic acids including major and minor groove binding moieties.

Transition metals are those whose atoms have a partial or complete d orbital shell of electrons. Suitable transition metals for use in conjunction with the present invention include, but are not limited to, cadmium (Cd), copper (Cu), cobalt (Co), palladium (Pd), zinc (Zn), iron (Fe), ruthenium (Ru), rhodium (Rh), osmium (Os), rhenium (Re), platinum (Pt), scandium (Sc), titanium (Ti), Vanadium (V), chromium (Cr), manganese (Mn), nickel (Ni), Molybdenum (Mo), technetium (Tc), tungsten (W), and iridium (Ir). That is, the first series of transition metals, the platinum metals (Ru, Rh, Pd, Os, Ir and Pt), along with Fe, Re, W, Mo and Tc, are preferred. Particularly preferred are ruthenium, rhenium, osmium, platinum, cobalt and iron.

The transition metals are commonly complexed with a variety of ligands, to form suitable transition metal complexes. As will be appreciated by those in the art, the number and nature of the co-ligands will depend on the coordination number of the metal ion. Mono-, di- or polydentate co-ligands may be used at any position. Suitable ligands fall into two categories: ligands, which use nitrogen, oxygen, sulfur, carbon or phosphorus atoms (depending on the metal ion) as the coordination atoms (generally referred to in the literature as sigma (Σ) donors) and organometallic ligands such as metallocene ligands (generally referred to in the literature as pi (π) donors). Suitable nitrogen donating ligands are well known in the art and include, but are not limited to, NH₂; NHR; NRR′; pyridine; pyrazine; isonicotinamide; imidazole; bipyridine and substituted derivatives of bipyridine; terpyridine and substituted derivatives; phenanthrolines, particularly 1,10-phenanthroline (abbreviated phen) and substituted derivatives of phenanthrolines such as 4,7-dimethylphenanthroline and dipyridol[3,2-a:2′,3′-c]phenazine (abbreviated dppz); dipyridophenazine; 1,4,5,8,9,12-hexaazatriphenylene (abbreviated hat); 9,10-phenanthrenequinone diimine (abbreviated phi); 1,4,5,8-tetraazaphenanthrene (abbreviated tap); 1,4,8,11-tetra-azacyclotetradecane (abbreviated cyclam), EDTA, EGTA and isocyanide. Substituted derivatives, including fused derivatives, may also be used. In some embodiments, porphyrins and substituted derivatives of the porphyrin family may be used. See for example, Comprehensive Coordination Chemistry, Ed. Wilkinson et al., Pergammon Press, 1987, Chapters 13.2 (pp 73-98), 21.1 (pp. 813-898) and 21.3 (pp 915-957), all of which are hereby expressly incorporated by reference.

Suitable sigma donating ligands using carbon, oxygen, sulfur and phosphorus are known in the art. For example, suitable sigma carbon donors are found in Cotton and Wilkinson, Advanced Organic Chemistry, 5th Edition, John Wiley & Sons (1988), hereby incorporated by reference; see, e.g., page 38. Similarly, suitable oxygen ligands include crown ethers, water and others known in the art. Phosphines and substituted phosphines are also suitable; see, e.g., page 38 of Cotton and Wilkinson. The oxygen, sulfur, phosphorus and nitrogen-donating ligands are attached in such a manner as to allow the heteroatoms to serve as coordination atoms.

Such organometallic ligands include cyclic aromatic compounds such as the cyclopentadienide ion [C₅H₅ (−1)] and various ring substituted and ring fused derivatives, such as the indenylide (−1) ion, that yield a class of bis(cyclopentadieyl) metal compounds, (i.e. the metallocenes); see, e.g., Robins et al., J. Am. Chem. Soc. 104:1882-1893 (1982); and Gassman et al., J. Am. Chem. Soc. 108:4228-4229 (1986), incorporated by reference. Of these, ferrocene [(C₅H₅)₂ Fe] and its derivatives are prototypical examples, which have been used in a wide variety of chemical (Connelly et al., Chem. Rev. 96:877-910 (1996), incorporated by reference) and electrochemical (Geiger et al., Advances in Organometallic Chemistry 23:1-93; and Geiger et al., Advances in Organometallic Chemistry 24:87, incorporated by reference) electron transfer or “redox” reactions. Metallocene derivatives of a variety of the first, second and third row transition metals are potential candidates as redox moieties that are covalently attached to the nucleic acid. Other potentially suitable organometallic ligands include cyclic arenes such as benzene, to yield bis(arene)metal compounds and their ring substituted and ring fused derivatives, of which bis(benzene)chromium is a prototypical example. Other acyclic pi-bonded ligands such as the allyl(−1) ion, or butadiene yield potentially suitable organometallic compounds, and all such ligands, in conjunction with other pi-bonded and delta-bonded ligands constitute the general class of organometallic compounds in which there is a metal to carbon bond. Electrochemical studies of various dimers and oligomers of such compounds with bridging organic ligands, and additional non-bridging ligands, as well as with and without metal-metal bonds are potential candidate redox moieties in nucleic acid analysis.

When one or more of the co-ligands is an organometallic ligand, the ligand is generally attached via one of the carbon atoms of the organometallic ligand, although attachment may be via other atoms for heterocyclic ligands. Preferred organometallic ligands include metallocene ligands, including substituted derivatives and the metalloceneophanes (see page 1174 of Cotton and Wilkenson, supra). For example, derivatives of metallocene ligands such as methylcyclopentadienyl, with multiple methyl groups being preferred, such as pentamethylcyclopentadienyl, can be used to increase the stability of the metallocene. In a preferred embodiment, only one of the two metallocene ligands of a metallocene is derivatized.

Alternatively, in some embodiments, a nucleic acid strand attached to a capture moiety may be labeled with an electroactive marker. Such electroactive markers can include, but are not limited to, ferrocene derivatives, anthraquinone, silver and silver derivatives, gold and gold derivatives, osmium and osmium derivatives, ruthinium and ruthinium derivatives, cobalt and cobalt derivatives and the like.

### EXAMPLE I

### Preparation of DNA-Antibody Conjugates

An oligonucleotide can be prepared on a solid support that has been treated with 3-amino-1,2-propanediol in order to introduce the 3′ amino group with an automated DNA synthesizer (e.g., 3400 DNA synthesizer, Applied Biosystems). Typical cleavage and purification steps are employed to obtain the modified oligonucleotide. The oligonucleotide is then incubated with N-succinimidyl 3-(2-pyridyldithio)propionate in PBS at a molar ratio between 1:30 to 1:35 for 30 minutes at room temperature. Dithiothreitol is typically added to this solution, resulting in a final concentration of 10 mM for 5 minutes. The oligonucleotide is then purified and recovered by applying this reaction mixture to a PBS equilibrated Sepharose column, washing the column several times, and eluting the oligonucleotide in a 0.6M NaCl phosphate buffer.

A monoclonal antibody is incubated with y-maleimidobutyric acid-N-hydroxysuccinimide ester in PBS at a molar ratio of between 1:15 and 1:20 for 30 minutes at room temperature. The maleimide derivatized antibody can then be purified by column chromatography.

The conjugation of the monoclonal antibody and the oligonucleotide is typically achieved by mixing the maleimide derivatized antibody and the sulphydryl containing oligonucleotide in a molar ratio between 1:10 and 1:16 and incubated overnight at 4° C. The resulting conjugates are purified by precipitation with a 50% saturated solution of (NH₄)₂SO₄ and extensive washing in the same (NH₄)₂SO₄ solution. Residual (NH₄)₂SO₄ can then be removed by dissolving the precipitate in PBS and gel filtration.

### EXAMPLE II

### Immobilization of Nucleic Acid Probe to a Platinum Electrode Surface

A platinum electrode is exposed to a high temperature to air-oxidize the surface of the electrode. The oxidized electrode is treated with cyanogen bromide (CNBr) to activate the oxide layer. The nucleic acid is attached to the electrode by contacting the electrode in a solution of single stranded nucleic acid. The single stranded nucleic acid is obtained by commonly employed means including, but not limited to, either standard oligonucleotide synthesis techniques or by thermal denaturation of a double stranded nucleic acid molecule.

Alternatively, a custom synthesized oligonucleotide containing a thiol group at the 5′ or the 3′ end is spotted on a gold electrode. This procedure involves placing approximately 100 nL of the probe solution containing the oligonucleotide probe (5 μmol/L), 400 mmol/L sodium chloride, and 0.1 mmol/L HCl, on the electrode and then keeping the electrode at room temperature for 1 h thereby resulting in the probes be immobilized onto the gold surface via a thiol moiety. Unattached probes are removed by washing the electrode with distilled water.

### EXAMPLE III

### Cleavage of the Antibody from the Nucleic Acid Strand

Following the isolation of the target bound conjugates, it may be desirable in some instances to remove the antibody and the target agent from the nucleic acid prior to hybridization. This is accomplished by performing a cleavage reaction to cleave the nucleic acid between the portion of the nucleic acid that will hybridize to the electrode immobilized nucleic acid molecule and the conjugated antibody.

An oligonucleotide is synthesized as described in Example I with a “G-G-C-C” sequence between the conjugated antibody and the portion of the oligonucleotide that will hybridize to the electrode immobilized nucleic acid molecule. The restriction endonuclease, HaeIII (New England Biolabs), has been shown to cleave single stranded DNA at this specific sequence (Horiuchi & Zinder, 1975). The cleavage reaction is performed by mixing the HaeIII enzyme with the antibody-nucleic acid conjugate in a buffer containing 10 mM Tris-HCl, 50 mM NaCl, 10 mM MgCl₂, 1 mM dithiothreitol, pH 7.9, and incubating at 37° C. for 30 minutes. The HaeIII enzyme is heat inactivated at 80° C. for 20 minutes. The cleaved nucleic acid molecules are separated from the antibody-antigen complex by standard techniques such as ethanol precipitation. Briefly, add 2.5-3 volumes of 95% ethanol/0.12 M sodium acetate to the DNA sample contained in a 1.5 ml microcentrifuge tube, invert to mix, and incubate in an ice-water bath for 10 minutes. The resulting mixture is centrifuged at 12,000 rpm in a microcentrifuge for 15 min at 4° C., decant the supernatant, and drain inverted on a paper towel. Ethanol (80%) (corresponding to about two volume of the original sample) is added and the reaction mixture is incubated at room temperature for 5-10 min followed by centrifugation for 5 min. The supernatant is then decanted. The sample is air dried (or alternatively lyophilized) and the pellet of DNA resuspended in 10 mM Tris-HCl, pH 7.6-8.0, 0.1 mM EDTA. For hybridization reactions, the nucleic acid is resuspended in SSC solution.

In an alternative cleavage method, photocleavage is performed. In doing so, an oligonucleotide is synthesized as described in Example I with a photocleavable nucleotide inserted into the sequence. This can be accomplished by using a photocleavable phosphoramidite during the synthesis of the oligonucleotide (Glen Research). The cleavage reaction is essentially performed by exposing the oligonucleotide-antibody conjugate to a source of ultraviolet (UV) light. The cleaved nucleic acid molecules are separated from the antibody-antigen complex by standard techniques such as ethanol precipitation, membrane filtration, or if the antibody-antigen complex is immobilized, but centrifugation, etc.

### EXAMPLE IV

### Hybridization of Nucleic Acid Molecules to the Electrode-Immobilized Nucleic Acid Molecules

The hybridization and detection reaction is carried out as follows. Single stranded nucleic acid in 2×SSC solution (300 mmol/L NaCl, 30 mmol/L trisodium citrate) are contacted with the probes immobilized on the electrode. The hybridization reaction is carried out at a temperature that permits specific hybridization of the two nucleic acid molecules. The temperature of the hybridization reaction is performed is determined using the equation for calculating the melting temperature of an oligonucleotide. It is possible to shorten the incubation time of this hybridization reaction by applying 0.1 V to the electrode. Using this procedure it may be possible to shorten the incubation time to 10 minutes.

To enhance detection, an electrochemical hybridization indicator, such as a minor groove binder is added. Briefly, a solution containing 50 μmol/L Hoechst 33258 (WAKO Pure Chemicals Industries, Ltd.) and 100 mmol/L NaCl is added before, during, or after hybridization. If the Hoechst 33258 is added after the hybridization reaction, then a further incubation of 5 minutes may be necessary. The electrochemical analysis is carried out with an electrochemical analyzer (Model BAS-100B) and software from Bioanalytical Systems, Inc. or the Genelyzer System from Toshiba Corporation. The cyclic voltammetry is typically carried out at 300 mV/s and 25° C., and the potential sweep range from −100 to 900 mV.

While this invention is satisfied by embodiments in many different forms, as described in detail in connection with the various embodiments of the invention, it is understood that the present disclosure is to be considered as exemplary of the principles of the invention and is not intended to limit the invention to the specific embodiments illustrated and described herein. Numerous variations may be made by persons skilled in the art without departure from the spirit of the invention. The abstract and the title are not to be construed as limiting the scope of the present invention, as their purpose is to enable the appropriate authorities, as well as the general public, to quickly determine the general nature of the invention. The scope of the invention will be measured by the appended claims along with the full scope of equivalents to which such claims are entitled. In the claims that follow, unless the term “means” is used, none of the features or elements recited therein should be construed as means-plus-function limitations pursuant to 35 U.S.C. §112, ¶6. All publications mentioned herein are cited for the purpose of describing and disclosing reagents, methodologies and concepts that may be used in connection with the present invention. Nothing herein is to be construed as an admission that these references are prior art in relation to the inventions described herein. Throughout the disclosure various patents, patent applications and publications are referenced. Unless otherwise indicated, each is incorporated by reference in its entirety for all purposes.

What is claimed is:

1. An electrochemical detection device for detection of a target agent comprising:
a chassis connected to an electrical system, a fluidics system, and a thermal system;
said electrical system comprising at least one circuit board;
said fluidics system comprising fluid paths, a pump connected to said fluid paths, at least one air path, reagent reservoirs, valves connecting said fluid paths to said reagent reservoirs, at least one valve connecting an air intake to said at least one air path;
said thermal system comprising a cooling means and a heating means; and
means for electrically detecting a hybridization event between oligonucleotides, wherein said hybridization event indicates said detection of said target agent.

2. The electrochemical detection device of claim 1, further comprising a cavity in which to mount at least a first of said at least one circuit board.

3. The electrochemical detection device of claim 1, further comprising a pass-through for an electrical connection.

4. The electrochemical detection device of claim 1, wherein said heating means is disposed on a bottom surface of said cooling means.

5. The electrochemical detection device of claim 1, wherein said heating means is selected from the group consisting of a film-type heater, a thermoelectric cooler or peltier device, a resistive heater, a cartridge heater, a Kapton heater, a rubber heater, a wire heater, a trace heater, and a thermoelectric module.

6. The electrochemical detection device of claim 1, wherein said cooling means comprises a fan and a heat sink.

7. The electrochemical detection device of claim 1, wherein said thermal system further comprises a temperature monitoring means.

8. The electrochemical detection device of claim 7, wherein said temperature monitoring means is positioned immediately adjacent to or within said heating means.

9. The electrochemical detection device of claim 1, wherein said at least one circuit board comprises a control board and a processing board.

10. The electrochemical detection device of claim 9, further comprising an electrical interface between said control board and said processing board.

11. The electrochemical detection device of claim 10, wherein said control board connects to a pump motor of said pump, said heating means, a fan of said cooling means, said valves, said processing board and a power supply.

12. The electrochemical detection device of claim 1, wherein said chassis does not comprise internal tubing.

13. The electrochemical detection device of claim 12, wherein said chassis is a fluidics monoblock.

14. The electrochemical detection device of claim 13, wherein said fluidics monoblock is made of at least one of the materials selected from the group comprising polymethyl methacrylate, acrylonitrile butadiene styrene, polyvinyl chloride, polycarbonate, or a combination thereof.

15. The electrochemical detection device of claim 1, further comprising a power supply.

16. The electrochemical detection device of claim 1, further comprising an electrochemical detection chip having an electrode with single-stranded nucleic acids disposed thereon.

17. The electrochemical detection device of claim 16, wherein said single-stranded nucleic acids are electrode-associated universal oligos.

18. The electrochemical detection device of claim 16, further comprising an electrical connection to said electrochemical detection chip.

19. The electrochemical detection device of claim 16, wherein said single-stranded nucleic acids are complementary to capture-associated oligos not found in a sample potentially comprising said target agent.

20. The electrochemical detection device of claim 19, wherein said capture-associated oligos are capture-associated universal oligos.

21. The electrochemical detection device of claim 19, wherein said capture-associated oligos were at one time conjugated to capture moieties that specifically bound to said target agent.

22. The electrochemical detection device of claim 16, further comprising a waste path for removing waste fluids from said electrochemical detection chip.

23. The electrochemical detection device of claim 16, wherein said at least one circuit board comprises a processing board and an electrical board, and further wherein said processing board comprises an electrical interface with said electrochemical detection chip through said electrical board.

24. The electrochemical detection device of claim 1, wherein said pump is selected from the group comprising a peristaltic pump, a diaphragm pump, a syringe-type pump, a gear pump, and a pipette-type pump.

25. The electrochemical detection device of claim 1, wherein a seal in said pump stays dry during use.

26. The electrochemical detection device of claim 1, wherein a seal in said pump is a spring-actuated seal.

27. The electrochemical detection device of claim 1, further comprising an aperture to accommodate said pump.

28. The electrochemical detection device of claim 1, wherein at least one of said valves is selected from the group comprising a solenoid valve, a shear valve, a pneumatically activated valve, and a pinch valve.

29. The electrochemical detection device of claim 1, wherein said reagent reservoirs hold enough reagent for multiple uses.

30. The electrochemical detection device of claim 1, wherein said fluidics system or a portion of said fluidics system is modular and can be switched out.

31. A method for electrochemically determining a presence or absence of a target agent comprising:
providing a sample potentially comprising said target agent;
introducing said sample into an electrochemical detection chip to produce a loaded electrochemical detection chip;
providing said electrochemical detection device of claim 1;
mounting said loaded electrochemical detection chip onto said electrochemical detection device of claim 1;
running an electrochemical detection protocol, wherein said electrochemical detection protocol produces results that indicate if hybridization of nucleic acid molecules occurred within said electrochemical detection chip;
analyzing said results, wherein if said results indicate that said hybridization did occur, then said results are indicative of a presence of said target agent in said sample, and if said results indicate that said hybridization did not occur, then said results are indicative of an absence of said target agent in said sample.

32. A handheld device for the detection of target agents via hybridization of oligonucleotides comprising:
(a) a first module comprising a first housing forming one or more reagent chambers, wherein said first housing comprises at a first end, means for receiving one or more reagent delivery means and at a second end, a first chamber structure formed by said first housing, wherein said first chamber structure is fluidly connected to said one or more reagent chambers by one or more reagent ports; and
(a) a second module comprising a second housing forming a sensor chamber wherein said second housing comprises at a first end, a second chamber structure capable of coupling to said first chamber structure to form a substantially fluid-tight chamber around said sample collection element and at a second end comprises means to supply power to said handheld device, electronics to process an electrical signal and an indicator means, wherein said sensor chamber is fluidly connected to said second chamber by a sensor port, and wherein said sensor chamber comprises single-stranded oligonucleotides disposed upon an electrode and electrical means to generate an electrical signal if a hybridization event between oligonucleotides is detected.

33. The handheld device of claim 1, further comprising an indicator reagent chamber formed within said second housing, fluidly connected to an indicator port formed within said second housing which is fluidly connected to said sensor chamber.

34. The handheld device of claim 1, wherein said first housing comprises two reagent chambers.

35. The handheld device of claim 3, wherein said first housing comprises a waste receptacle.

36. The handheld device of claim 1, further comprising a sample collection element.

37. The handheld device of claim 5, wherein said sample collection element is disposed within said first chamber structure formed by said first housing.

38. The handheld device of claim 5, wherein said sample collection element is disposed within said second chamber structure formed by said second housing.

39. The handheld device of claim 1, wherein said sensor port is a filtering port.

40. The handheld device of claim 1, wherein said reagent delivery means is a plunger.

41. A handheld device for the detection of target agents via hybridization of oligonucleotides comprising:
(a) a first module comprising a first housing forming one or more reagent chambers, wherein said first housing comprises at a first end, means for receiving one or more reagent delivery means and at a second end, a first chamber structure formed by said first housing, wherein said first chamber structure is fluidly connected to said one or more reagent chambers by one or more reagent ports; and
(b) a second module comprising a second housing forming a sensor chamber wherein said second housing comprises at a first end, a second chamber structure capable of coupling to said first chamber structure to form a substantially fluid-tight chamber around said sample collection element and at a second end comprises means to supply power to said handheld device, electronics to process an electrical signal and an indicator means, wherein said sensor chamber is fluidly connected to said second chamber by a sensor port, and wherein said sensor chamber comprises single-stranded oligonucleotides disposed upon an electrode and electrical means to generate an electrical signal if a hybridization event between oligonucleotides is detected.

42. The handheld device of claim 41, further comprising an indicator reagent chamber formed within said second housing, fluidly connected to an indicator port formed within said second housing which is fluidly connected to said sensor chamber.

43. The handheld device of claim 41, wherein said first housing comprises two reagent chambers.

44. The handheld device of claim 43, wherein said first housing comprises a waste receptacle.

45. The handheld device of claim 41, further comprising a sample collector element.

46. The handheld device of claim 45, wherein said sample collector element is disposed within said first chamber structure formed by said first housing.

47. The handheld device of claim 45, wherein said sample collector element is disposed within said second chamber structure formed by said second housing.

48. The handheld device of claim 41, wherein said sensor port is a filtering port.

49. The handheld device of claim 41, wherein said reagent delivery means is a plunger.
